(19) United States
(12) Patent Application Publication
(10) Pub. No.: US 2005/0234247 A1
(43) Pub. Date: Oct. 20, 2005

(54) New effector conjugates, process for their production and their pharmaceutical use

(76) Inventors: Ulrich Klar, Berlin (DE); Joerg Willuda, Berlin (DE); Andreas Menrad, Oranienburg (DE); Klaus Bosslet, Berlin (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/045,503

(22) Filed: Jan. 31, 2005

(30) Foreign Application Priority Data
Jan. 30, 2004 (DE) 102004004787.1

(51) Int. Cl. C07F 9/28

(52) U.S. Cl. 549/217

(57) ABSTRACT

Conjugates of epothilones and epothilone derivatives (as effectors) with suitable biomolecules (as recognition units) are described. Their production is carried out by the effectors being reacted with suitable linkers, and the compounds that are produced are conjugated to the recognition units. The pharmaceutical use of conjugates for treating proliferative or angiogenesis-associated processes is described.

This application claims the benefit of the filing date of U.S. Provisional Application Ser. No. 60/539,977 filed Jan. 30, 2004.

The development of the understanding relative to the recognition of binding regions, especially in the field of monoclonal antibodies or their fragments from specific tumor antigens, makes it possible to conceive a selective tumor therapy by specific release of an anti-tumor active ingredient at the target site.

A requirement for such an approach, in which a highly active (toxic) active ingredient (effector) is coupled to a high-molecular tumor-specific recognition unit, such as, for example, to an antibody, is a substantial inactivity of the conjugate, whose least components represent a recognition unit and an effector, until the latter has reached the target site (tumor). When the target site is reached, the conjugate binds to the cell surface, and the active ingredient can be released optionally after the entire complex is first internalized.

The successful therapy of solid tumors, especially with monoclonal antibodies, can be limited, however, by an inadequate penetration of the antibody in the tumor as well as the heterogeneous distribution of the corresponding tumor-associated antigen in the tumor tissue.

These limitations thus could be avoided by having the tumor-vascular system be attacked in a specific way. The growth of tumors below a volume of about 2 mm³ is based on a neoangiogenesis. The additional tumor growth is based on an intact vascular system, which ensures the supply with nutrients or disposal of waste products. The selective destruction of this system should therefore result in a necrosis of the tumor. Attacking the vascular system of the tumor offers a number of advantages compared to the direct attack on the tumor itself. In comparison to tumor cells, endothelial cells are easier to access, since no tumor tissue has to be penetrated. The damage of an individual tumor vessel should result in the necrosis of a thousand tumor cells. To damage a tumor vessel, it is not necessary to kill off all endothelial cells. The specific attack of endothelial cells in or near tumors minimizes systemic side effects. Endothelial cells are genetically very stable, such that the probability of a development of resistance against the tumor therapeutic agent is low.

Within the scope of this invention, surprisingly enough, a possibility has now been found to link the chemically very sensitive, highly-functionalized active ingredient class of the epothilones and analogs thereof with a high-molecular recognition unit via different linkers that are distinguished in that they can be cleaved selectively by intracellular at various positions of the active ingredient.

The object of this invention is thus based on, i.a.,
1. Finding a method to link highly active active ingredients from the structural class of the epothilones and epothilone derivatives with suitable linkers,
2. Synthesizing suitable, intracellularly cleavable linkers;
3. Developing a method to link these epothilone-linker conjugates to recognition units, such as, for example, monoclonal antibodies or their fragments, to immune conjugates, which are sufficiently stable both chemically and metabolically for a pharmaceutical agent development and which are superior to the epothilone or epothilone derivatives that are the underlying compounds with respect to their therapeutic width, their selectivity of action and/or undesirable toxic side effects and/or their active strength.

This invention correspondingly comprises effector conjugates of general formula I 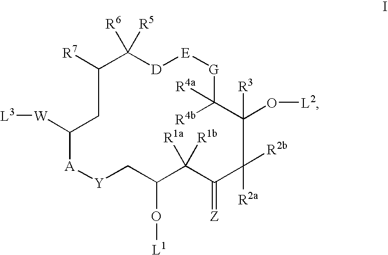
in which
R^{1a}, R^{1b}, independently of one another, are hydrogen, C₁-C₁₀ alkyl, aryl, aralkyl, or together a —CH₂)ₘgroup, in which m is 2 to 5,
R^{2a}, R^{2b}, independently of one another, are hydrogen, C₁-C₁₀ alkyl, aryl, aralkyl, or together a —CH₂)ₙ group, in which n is 2 to 5, or C₂-C₁₀ alkenyl, or C₂-C₁₀ alkinyl,
R³ is hydrogen, C₁-C₁₀ alkyl, aryl or aralkyl, and
R^{4a}, R^{4b}, independently of one another, are hydrogen, C₁-C₁₀ alkyl, aryl, aralkyl, or together a —CH₂)ₚ group, in which p is 2 to 5,
R⁵ is hydrogen, C₁-C₁₀ alkyl, aryl, aralkyl, CO₂H, CO₂alkyl, CH₂OH, CH₂-alkyl, CH₂Oacyl, CN, CH₂NH₂, CH₂N(alkyl, acyl)_{1,2}, or CH₂Hal,
Hal is a halogen atom,
R⁶, R⁷, in each case, are hydrogen, or together an additional bond or together an oxygen atom, or together an NH group, or together an N-alkyl group, or together a CH₂ group, and
G is an oxygen atom or CH₂,
D-E is a group H₂C—CH₂, HC═CH, C≡C, CH(OH)—CH(OH), CH(OH)—CH₂, CH₂—CH(OH), 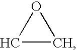
   O—CH₂, or, if G represents a CH₂ group, D-E is also CH₂—O,
W is a group C(═X)R⁸, or a bi- or tricyclic aromatic or heteroaromatic radical,
L³ is hydrogen, or, if a radical in W contains a hydroxyl group, forms a group O-L⁴ with the latter, or, if a radical in W contains an amino group, forms a group NR²⁵-L⁴ with the latter,
R²⁵ is hydrogen or C₁-C₁₀ alkyl,
X is an oxygen atom, or two OR²⁰ groups, or a C₂-C₁₀alkylenedioxy group, which should be straight-chain or branched, or H/OR⁹, or a CR¹⁰R¹¹ group,
R⁸ is hydrogen, C₁-C₁₀ alkyl, aryl, aralkyl, halogen or CN, and
R⁹ is hydrogen or a protective group PG^{X},
R¹⁰, R¹¹, in each case independently of one another, are hydrogen, C₁ -C₂₀ alkyl, aryl, or aralkyl, or together with a methylene carbon atom form a 5- to 7-membered carbocyclic ring,
Z can represent oxygen or H/OR¹²,
R¹² can represent hydrogen or a protective group PG^{Z},
A-Y can represent a group O—C(═O), O—CH₂, CH₂—C(═O), NR²¹—C(═O) or NR²¹—SO₂,
R²⁰ can represent C₁-C₂₀ alkyl,
R²¹ can represent a hydrogen atom or C₁-C₁₀ alkyl,
PG^{X}, PG^{Y}, and PG^{Z} can represent a protective group PG, and
L¹, L², L⁴, independently of one another, can represent hydrogen, a group C(═O)Cl, a group PG^{Y} or a linker of general formula III;
   with the condition that at least one substituent L¹, L² or L⁴ represents a linker of general formula (III);
      the linker of general formula (III) has the following structure, 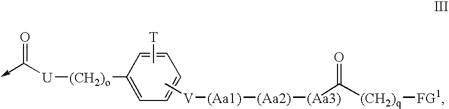
      in which
T represents halogen, OH, O-alkyl, CO₂H, CO₂-alkyl, —NHR²³, —NO₂, —N₃, —CN, C₁-C₂₀-alkyl, C₁-C₂₀-acyl or C₁-C₂₀-acyloxy groups,
U represents a bond, oxygen, or NR^{24a},
o represents 0 to 5,
V represents oxygen or NR^{24b},
Aa1 represents a bond or a group of general formula IV and
Aa2, Aa3, independently of one another, represent a group of general formula IV 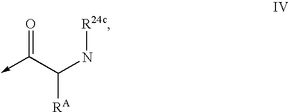
   which is derived from a natural or unnatural amino acid HO-Aa1-H, HO-Aa2-H, or HO-Aa3-H of general formula IV′ 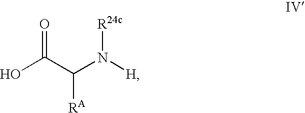
   in which R^{A} can be the same or different in HO-Aa1-H, HO-Aa2-H, or HO-Aa3-H, and the a-substituent represents a natural or unnatural amino acid,
R²² can represent hydrogen, C₁-C₁₀ alkyl, aryl or aralkyl,
R²³ can represent hydrogen, C₁-C₁₀ alkyl, or C₁-C₁₀ acyl,
R^{24a}, R^{24b}, R^{24c}, independently of one another, can represent hydrogen or C₁-C₁₀ alkyl,
q can represent 1 to 20,
FG¹ can represent C₁-C₁₀ alkyl-S₃, 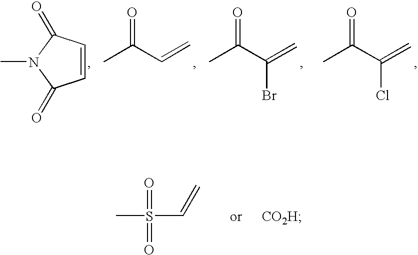
   as a uniform isomer or a mixture of different isomers and/or as a pharmaceutically acceptable salt thereof.

In addition, the invention describes the production of effect-recognition unit conjugates of general formula (I), whereby the substituents here have the above-mentioned meanings, but at least one group FG¹ is replaced by a group FG^{2a} or FG^{2b}, whereby FG^{2a} or FG^{2b} can have the following meanings: 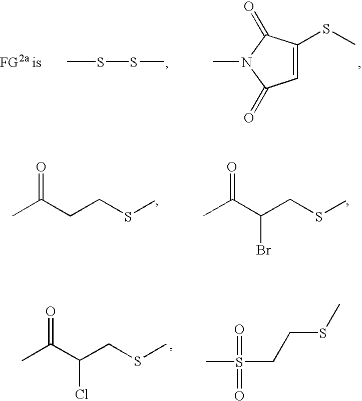
FG^{2b} is —CONH—
and whereby a recognition unit is conjugated via a sulfur atom with the group FG^{2a}, whereby the sulfur atom that is shown is a component of the recognition unit, or via an amide group with group FG^{2b}, whereby the nitrogen atom that is shown is a component of the recognition unit;
whereby the recognition unit can be, for example, a peptide, a soluble receptor, a cytokine, a lymphokine, an aptamer, a spiegelmer, a recombinant protein, a framework structure, a monoclonal antibody or a fragment of a monoclonal antibody.

The thiol groups that are required for a conjugation, at least one thiol group is required, can already be included in the recognition unit or can be produced, for example, by reductive cleavage of disulfide bridges or by functionalization of suitable amino acid units according to the methods that are known to one skilled in the art. For example, the reaction of proteins that contain amino groups with Traut's reagent can be mentioned.

According to this invention, the above-mentioned effector-recognition unit conjugates can comprise one or more recognition units; in this case, the recognition units that correspond to a conjugate can be identical or different. It is preferred that the recognition units of a conjugate be identical.

The effector-recognition unit conjugates according to the invention can be used in the form of their α-, β- or γ-cyclodextrin clathrates or in the form of liposomal or pegylated compositions.

The conjugates according to the invention are preferably used for the treatment of diseases that are linked with proliferative processes. For example, the therapy of widely varying tumors, the therapy of inflammatory and/or neurodegenerative diseases, such as multiple sclerosis or Alzheimer's disease, the therapy of angiogenesis-associated diseases, such as the growth of solid tumors, rheumatoid arthritis or diseases of the ocular fundus can be mentioned.

The production of epothilones, their precursors and derivatives of general formula I is carried out according to the methods that are known to one skilled in the art, as they are described in, for example, DE 19907588, WO 98/25929, WO 99/58534, WO 99/2514, WO 99/67252, WO 99/67253, WO 99/7692, EP 99/4915, WO 00/485, WO 00/1333, WO 00/66589, WO 00/49019, WO 00/49020, WO 00/49021, WO 00/71521, WO 00/37473, WO 00/57874, WO 01/92255, WO 01/81342, WO 01/73103, WO 01/64650, WO 01/70716, U.S. Pat. No. 6,204,388, U.S. Pat. No. 6,387,927, U.S. Pat. No. 6,380,394, U.S. Ser. No. 02/52028, U.S. Ser. No. 02/58286, U.S. Ser. No. 02/62030, WO 02/32844, WO 02/30356, WO 02/32844, WO 02/14323, and WO 02/8440.

As alkyl groups R^{1a}, R^{1b}, R^{2a}, R^{2b}, R³, R^{4a}, R^{4b}, R⁵, R⁸, R¹⁰, R¹¹, R²⁰, R²¹, R²², R²³, R^{24a}, R^{24b}, R^{24c}, R²⁵, and R²⁶, straight-chain or branched-chain alkyl groups with 1-20 carbon atoms can be considered, such as, for example, methyl, ethyl, propyl, isopropyl, butyl, isobutyl, tert.-butyl, pentyl, isopentyl, neopentyl, heptyl, hexyl, and decyl.

Alkyl groups R^{1a}, R^{1b}, R^{2a}, R^{2b}, R³, R^{4a}, R^{4b}, R⁵, R⁸, R¹⁰, R¹¹, R²⁰, R²¹, R²², R²³, R^{24a}, R^{24b}, R^{24c}, R²⁵ and R²⁶ can also be perfluorinated or substituted by 1-5 halogen atoms, hydroxy groups, C₁-C₄-alkoxy groups, or C₆-C₁₂-aryl groups (which can be substituted by 1-3 halogen atoms).

As aryl radicals R^{1a}, R^{1b}, R^{2a}, R^{2b}, R³, R^{4a}, R^{4b}, R⁵, R⁸, R¹⁰, R¹¹, R²², and R²⁶, substituted and unsubstituted carbocyclic or heterocyclic radicals with one or more heteroatoms, such as phenyl, naphthyl, furyl, thienyl, pyridyl, pyrazolyl, pyrimidinyl, oxazolyl, pyridazinyl, pyrazinyl, quinolyl, thiazolyl, benzothiazolyl, or benzoxazolyl, which can be substituted in one or more places by halogen, OH, O-alkyl, CO₂H, CO₂-alkyl, —NH₂, —NO₂, —N₃, —CN, C₁-C₂₀-alkyl, C₁-C₂₀-acyl, or C_{1-C}₂₀-acyloxy groups, are suitable. The heteroatoms can be oxidized if as a result the aromatic character is not lost, such as, for example, the oxidation of a pyridyl to a pyridyl-N-oxide.

As bi- and tricyclic aryl radicals W, substituted and unsubstituted carbocyclic or heterocyclic radicals with one or more heteroatoms, such as naphthyl, anthryl, benzothiazolyl, benzoxazolyl, benzimidazolyl, quinolyl, isoquinolyl, benzoxazinyl, benzofuranyl, indolyl, indazolyl, quinoxalinyl, tetrahydroisoquinolinyl, tetrahydroquinolinyl, thienopyridinyl, pyridopyridinyl, benzopyrazolyl, benzotriazolyl, or dihydroindolyl, which can be substituted in one or more places by halogen, OH, O-alkyl, CO₂H, CO₂-alkyl, —NH₂, —NO₂, —N₃, —CN, C₁-C₂₀-alkyl, C₁-C₂₀-acyl, or C₁-C₂₀-acyloxy groups, are suitable. The heteroatoms can be oxidized if as a result the aromatic character is not lost, such as, for example, the oxidation of a quinolyl to a quinolyl-N-oxide.

The aralkyl groups in R^{1a}, R^{1b}, R^{2a}, R^{2b}, R³, R^{4a}, R^{4b}, R⁵, R⁸, R¹⁰, R¹¹, R²², and R²⁶ can contain in the ring up to 14 C atoms, preferably 6 to 10 C atoms, and in the alkyl chain 1 to 8 atoms, preferably 1 to 4 atoms. As aralkyl radicals, for example, benzyl, phenylethyl, naphthylmethyl, naphthylethyl, furylmethyl, thienylethyl, or pyridylpropyl are considered. The rings can be substituted in one or more places by halogen, OH, O-alkyl, CO₂H, CO₂-alkyl, —NO₂, —N₃, —CN, C₁-C₂₀-alkyl, C₁-C₂₀-acyl, or C₁ -C₂₀-acyloxy groups.

As representatives of protective groups PG, tris(C₁-C₂₀ alkyl)silyl, bis(C₁-C₂₀ alkyl)-arylsilyl, (C₁-C₂₀ alkyl)-diarylsilyl, tris(aralkyl)-silyl, C₁-C₂₀-alkyl, C₂-C₂₀-alkenyl, C₄-C₇-cycloalkyl, which in addition can contain an oxygen atom in the ring, aryl, C₇-C₂₀-aralkyl, C₁-C₂₀-acyl, aroyl, C₁-C₂₀-alkylsulfonyl as well as arylsulfonyl can be mentioned.

As alkyl, silyl and acyl radicals for protective groups PG, in particular the radicals that are known to one skilled in the art are considered. Preferred are the alkyl or silyl radicals that are easily cleavable from the corresponding alkyl ethers and silyl ethers, such as, for example, the methoxymethyl, methoxyethyl, ethoxyethyl, tetrahydropyranyl, tetrahydrofuranyl, trimethylsilyl, triethylsilyl, tert.-butyldimethylsilyl, tert.-butyldiphenylsilyl, tribenzylsilyl, triisopropylsilyl, benzyl, para-nitrobenzyl, or para-methoxybenzyl radical as well as alkylsulfonyl and arylsulfonyl radicals. As acyl radicals, e.g., formyl, acetyl, propionyl, isopropionyl, trichloromethylcarbonyl, pivalyl, butyryl or benzoyl, which can be substituted with amino groups and/or hydroxy groups, are suitable.

As amino protective groups PG, the radicals that are known to one skilled in the art are considered. For example, the Alloc, Boc, trityl, monomethoxy-trityl, Z, benzyl, f-Moc, Troc, Stabase or benzostabase group can be mentioned.

As halogen atoms, fluorine, chlorine, bromine or iodine is considered.

The acyl groups can contain 1 to 20 carbon atoms, whereby formyl, acetyl, propionyl, isopropionyl and pivalyl groups are preferred.

The C₂-C₁₀-alkylene-α,ω-dioxy group that is possible for X is preferably an ethyleneketal or neopentylketal group.

As natural or unnatural amino acids HO-Aa1-H, HO-Aa2-H, and HO-Aa3-H, there can be mentioned, for example: glycine, alanine, serine, proline, valine, threonine, cysteine, isoleucine, leucine, asparagine, asparaginic acid, glutamine, lysine, ornithine, glutamic acid, methionine, histidine, phenylalanine, arginine, tyrosine, tryptophan, citrulline, hydroxyproline, tetrahydroisoquinoline-3-carboxylic acid, α-pyridylalanine, α-naphthylalanine, p-nitrophenylalanine or homophenylalanine in each case in the D- or L- or D/L form or their salts. Free hydroxyl groups or free amino groups in which α-substituents of the natural or unnatural amino acids can optionally carry a protective group PG.

Preferred compounds of general formula I are those in which A-Y represents O—C(═O) or NR²¹—C(═O); D-E represents an H₂C—CH₂ group or an H₂C═CH₂ group; G represents a CH₂ group; Z represents an oxygen atom; R^{1a}, R^{1b} in each case represent C₁-C₁₀ alkyl or together a —CH₂)ₚ group with p equal to 2 or 3 or 4; R^{2a}, R^{2b}, independently of one another, represent hydrogen, C₁-C₁₀ alkyl, C₂-C₁₀ alkenyl, or C₂-C₁₀ alkinyl; R³ represents hydrogen; R^{4a}, R^{4b}, independently of one another, represent hydrogen or C₁-C₁₀ alkyl; R⁵ represents hydrogen or C₁-C₄ alkyl or CH₂OH or CH₂NH₂ or CH₂N(alkyl, acyl)_{1,2} or CH₂Hal; R⁶ and R⁷ together represent an additional bond or together an NH group or together an N-alkyl group or together a CH₂ group or together an oxygen atom; W represents a group C(═X)R⁸ or a 2-methylbenzothiazol-5-yl radical or a 2-methylbenzoxazol-5-yl radical or a quinolin-7-yl radical or a 2-aminomethylbenzothiazol-5-yl radical or a 2-hydroxymethylbenzothiazol-5-yl radical or a 2-aminomethylbenzoxazol-5-yl radical or a 2-hydroxymethyl-benzoxazol-5-yl radical; X represents a CR¹⁰R¹¹ group; R⁸ represents hydrogen or C₁-C₄ alkyl or a fluorine atom or a chlorine atom or a bromine atom; R¹⁰/R¹¹ represent hydrogen/2-methylthiazol-4-yl or hydrogen/2-pyridyl or hydrogen/2-methyloxazol-4-yl or hydrogen/2-aminomethylthiazol-4-yl or hydrogen/2-aminomethyloxazol-4-yl or hydrogen/2-hydroxymethylthiazol-4-yl or hydrogen/2-hydroxymethyloxazol-4-yl.

As linkers of general formula (III), compounds are preferred in which Aa1 represents a bond.

As linkers of general formula (III), in addition compounds are preferred in which FG¹ is C₁-C₁₀ alkyl-S₃ or

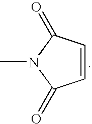

As recombinant proteins for use as recognition units, for example, binding regions that are derived from antibodies, so-called CDRs, are suitable.

As framework structures for use as recognition units, for example, high-molecular structures, which are not derived from antibodies, are suitable. For example, structures such as fibronectin-type 3 and crystallines can be mentioned.

As fragments of monoclonal antibodies for use as recognition units, for example, single-chain Fv, Fab, F(ab)₂ as well as recombinant multimers can be mentioned.

As preferred recognition units, those are considered that are suitable for, for example, the recognition and/or diagnosis and/or therapy of solid tumors and malignant diseases of the hematopoietic system.

As recognition units that are preferred in addition, those are considered that make possible a selective recognition of the disease-specific vascular system, preferably angiogenesis.

Table 1 cites examples of especially preferred recognition units for treating solid tumors.

TABLE 1

| | Antigen Identity/ | Monoclonal | |
|---|---|---|---|
| Tumor | Characteristics | Antibodies | References |
| Gynecol. (GY) | CA 125′ > 200 kD | OC 125 | Kabawat et al., 1983; |
| | mucin GP | | Szymendera, 1986 |
| Ovarian | 80 Kd GP | OC 133 | Masuko et al., Cancer Res, 1984 |
| Ovarian | ‘SGA’ 360 Kd GP | OMI | de Krester et al., 1986 |
| Ovarian | High Mᵣ mucin | Mo v1 | Miotti et al., Cancer Res, 1985 |
| Ovarian | High Mᵣ mucin/glycolipid | Mo v2 | Miotti et al., Cancer Res, 1985 |
| Ovarian | NS | 3C2 | Tsuji et al., Cancer Res, 1985 |
| Ovarian | NS | 4C7 | Tsuji et al., Cancer Res, 1985 |
| Ovarian | High Mᵣ mucin | ID3 | Gangopadhyay et al., 1985 |
| Ovarian | High Mᵣ mucin | DU-PAN-2 | Lan et al., 1985 |
| GY | 7700 Kd GP | F 36/22 | Croghan et al., 1984 |
| Ovarian | ‘gp 68’ 48 Kd GP | 4F₇/7A₁₀ | Bhattacharya et al., 1984 |
| GY | 40, 42 kD GP | OV-TL3 | Poels et al., 1986 |
| GY | ‘TAG-72’ High Mᵣ mucin | B72.3 | Thor et al., 1986 |
| Ovarian | 300-400 Kd GP | DF₃ | Kufe et al., 1984 |
| Ovarian | 60 Kd GP | 2C₈/2F₇ | Bhattacharya et al., 1985 |
| GY | 105 Kd GP | MF 116 | Mattes et al., 1984 |
| Ovarian | 38-40 kD GP | Mov18 | Miotti et al., 1987 |
| GY | ‘CEA’ 180 Kd GP | CEA 11-H5 | Wagener et al., 1984 |
| Ovarian | CA 19-9 or GICA | CA 19-9 (1116NS 19-9) | Atkinson et al., 1982 |
| Ovarian | ‘FLAP’ 67 Kd GP | H17-E2 | McDicken et al., 1985 |
| Ovarian | 72 Kd | 791T/36 | Perkins et al., 1985 |
| Ovarian | 69 Kd PLAP | NDOG₂ | Sunderland et al., 1984 |
| Ovarian | unknown Mᵣ PLAP | H317 | Johnson et al., 1981 |
| Ovarian | p185^{HER2} | 4D5, 3H4, 7C2, | Shepard et al., 1991 |
| | | 6E9, 2C4, 7F3, | |
| | | 2H11, 3E8, 5B8, | |
| | | 7D3, SB8 | |
| Uterus, Ovary | HMFG-2 | HMFG2 | Epenetos et al., 1982 |
| GY | HMFG-2 | 3.14.A3 | Burchell et al., 1983 |
| Breast | 330-450 Kd GP | DF3 | Hayes et al., 1985 |
| Breast | NS | NCRC-11 | Ellis et al., 1984 |
| Breast | 37 kD | 3C6F9 | Mandeville et al., 1987 |
| Breast | NS | MBE6 | Teramoto et al., 1982 |
| Breast | NS | CLNH5 | Glassy et al., 1983 |
| Breast | 47 Kd GP | MAC 40/43 | Kjeldsen et al., 1986 |
| Breast | High Mᵣ GP | EMA | Sloane et al., 1981 |
| Breast | High Mᵣ GP | HMFG1 HFMG2 | Arklie et al., 1981 |
| Breast | NS | 3.15.C3 | Arklie et al., 1981 |
| Breast | NS | M3, M8, M24 | Foster et al., 1982 |
| Breast | 1 (Ma) Blood Group Ags | M18 | Foster et al., 1984 |
| Breast | NS | 67-D-11 | Rasmussen et al., 1982 |
| Breast | Estrogen Receptor | D547Sp, D75P3, H222 | Kinsel et al., 1989 |
| Breast | EGF Receptor | Anti EGF | Sainsbury et al., 1985 |
| Breast | Laminine Receptor | LR-3 | Horan Hand et al., 1985 |
| Breast | erb B-2 p185 | TA1 | Gusterson et al., 1988 |
| Breast | NS | H59 | Hendler et al., 1981 |
| Breast | 126 Kd GP | 10-3D-2 | Soule et al., 1983 |
| Breast | NS | HmAB1, 2 | Imam et al., 1984; |
| | | | Schlom et al., 1985 |
| Breast | NS | MBR 1, 2, 3 | Menard et al., 1983 |
| Breast | 95 Kd | 24-17-1 | Thompson et al., 1983 |
| Breast | 100 Kd | 24-17-2 (3E1-2) | Croghan et al., 1983 |
| Breast | NS | F36/22.M7/105 | Croghan et al., 1984 |
| Breast | 24 Kd | C11, G3, H7 | Adams et al., 1983 |
| Breast | 90 Kd GP | B6-2 | Colcher et al., 1981 |
| Breast | CEA & 180 Kd GP | B1-1 | Colcher et al., 1983 |
| Breast | Colon & pancreas, | Cam 17-1 | Imperial Cancer |
| | mucin-like Ca 19-9 | | Research Technology |
| | | | MAb listing |
| Breast | Milk mucin, nuclear protein | SM3 | Imperial Cancer |
| | | | Research Technology |
| | | | Mab listing |
| Breast | Milk mucin, nuclear protein | SM4 | Imperial Cancer |
| | | | Research Technology |
| | | | Mab listing |
| Breast | Affinity-purified milk mucin | C-Mul (566) | Imperial Cancer |
| | | | Research Technology |
| | | | Mab listing |
| Breast | P185^{HER2} | 4D5 3H4, 7C2, | Shepard et al., 1991 |
| | | 6E9, 2C4, 7F3, | |
| | | 2H11, 3E8, 5B8, | |
| | | 7D3, 5B8 | |
| Breast | CA 125 > 200 Kd GP | OC 125 | Kabawat et al., 1985 |
| Breast | High Mᵣ mucin/glycolipid | MO v2 | Miotti et al., 1985 |
| Breast | High Mᵣ mucin | DU-PAN-2 | Lan et al., 1984 |
| Breast | ‘gp48’ 48 Kd GP | 4F₇/7A₁₀ | Bhattacharya et al., 1984 |
| Breast | 300-400 Kd GP | DF₃ | Kufe et al., 1984 |
| Breast | ‘TAG-72’ high Mᵣ mucin | B72-3 | Thor et al., 1986 |
| Breast | ‘CEA’ 180 Kd GP | cccccCEA 11 | Wagener et al., 1984 |
| Breast | ‘PLAP’ 67 Kd GP | H17-E2 | McDicken et al., 1985 |
| Breast | HMFG-2 > 400 Kd GP | 3-14-A3 | Burchell et al., 1983 |
| Breast | NS | FO23C5 | Riva et al., 1988 |
| Colorectal | TAG-72 High Mᵣ mucin | B72-3 | Colcher et al., 1987 |
| Colorectal | GP37 | (17-1A) 1038-17-1A | Paul et al., 1986 |
| Colorectal | Surface GP | CO17-1A | LoBuglio et al., 1988 |
| Colorectal | CEA | ZCE-025 | Patt et al., 1988 |
| Colorectal | CEA | AB2 | Griffin et al., 1988a |
| Colorectal | Cell surface AG | HT-29-15 | Cohn et al., 1987 |
| Colorectal | Secretory epithelium | 250-30.6 | Leydem et al., 1986 |
| Colorectal | Surface glycoprotein | 44X14 | Gallagher et al., 1986 |
| Colorectal | NS | A7 | Takahashi et al., 1988 |
| Colorectal | NS | GA73-3 | Munz et al., 1986 |
| Colorectal | NS | 791T/36 | Farrans et al., 1982 |
| Colorectal | Cell Membrane & | 28A32 | Smith et al., 1987 |
| | Cytoplasmatic Ag | | |
| Colorectal | CEA & Vindesin | 28.19.8 | Corvalen, 1987 |
| Colorectal | gp72 | X MMCO-791 | Byers et al., 1987 |
| Colorectal | high Mᵣ mucin | DU-PAN-2 | Lan et al., 1985 |
| Colorectal | high Mᵣ mucin | ID₃ | Gangopadhyay et al., 1985 |
| Colorectal | CEA 180 Kd GP | CEA 11-H5 | Wagener et al., 1984 |
| Colorectal | 60 Kd GP | 2C₈/2F₇ | Bhattacharya et al., 1985 |
| Colorectal | CA-19-9 (or GICA) | CA-19-9(1116NS 19-9) | Atkinson et al., 1982 |
| Colorectal | Lewis a | PR5C5 | Imperial Cancer |
| | | | Research Technology |
| | | | Mab Listing |
| Colorectal | Lewis a | PR4D2 | Imperial Cancer |
| | | | Research Technology |
| | | | Mab Listing |
| Colorectal | Colon mucus | PR4D1 | Imperial Cancer |
| | | | Research Technology |
| | | | Mab Listing |
| Melanoma | P97^{a} | 4-1 | Woodbury et al., 1980 |
| Melanoma | P97^{a} | 8-2 M₁₇ | Brown, et al., 1981a |
| Melanoma | P97^{b} | 96-5 | Brown, et al., 1981a |
| Melanoma | P97^{c} | 118-1, 133-2, (113-2) | Brown, et al., 1981a |
| Melanoma | P97^{c} | L₁, L₁₀, R₁₀ (R₁₉) | Brown et al., 1981b |
| Melanoma | P97^{d} | I₁₂ | Brown et al., 1981b |
| Melanoma | P97^{e} | K₅ | Brown et al., 1981b |
| Melanoma | P155 | 6-1 | Loop et al., 1981 |
| Melanoma | G_{D3} disialogan-gliosides | R24 | Dippold et al., 1980 |
| Melanoma | P210, p60, p250 | 5-1 | Loop et al., 1981 |
| Melanoma | P280 p440 | 225.28S | Wilson et al., 1981 |
| Melanoma | GP 94, 75, 70 & 25 | 465.12S | Wilson et al., 1981 |
| Melanoma | P240-P250, P450 | 9-2-27 | Reisfeld et al., 1982 |
| Melanoma | 100, 77, 75 Kd | F11 | Chee et al., 1982 |
| Melanoma | 94 Kd | 376.96S | Imai et al., 1982 |
| Melanoma | 4 GP Chains | 465.12S | Imai et al., 1982; Wilson |
| | | | et al., 1981 |
| Melanoma | GP 74 | 15-75 | Johnson & Reithmuller, 1982 |
| Melanoma | GP 49 | 15-95 | Johnson & Reithmuller, 1982 |
| Melanoma | 230 Kd | Mel-14 | Carrel et al., 1982 |
| Melanoma | 92 Kd | Mel-12 | Carrel et al., 1982 |
| Melanoma | 70 Kd | Me3-TB7 | Carrel et al., 1: 387, 1982 |
| Melanoma | HMW MAA similar to | 225.28SD | Kantor et al., 1982 |
| | 9-2-27 AG | | |
| Melanoma | HMW MAA similar to | 763.24TS | Kantor et al., 1982 |
| | 9-2-27 AG | | |
| Melanoma | GP95 similar to 376- | 705F6 | Stuhlmiller et al., 1982 |
| | 96S 465-12S | | |
| Melanoma | GP125 | 436910 | Saxton et al., 1982 |
| Melanoma | CD41 | M148 | Imperial Cancer |
| | | | Research Technology |
| | | | Mab listing |
| Gastrointestinal | high Mᵣ mucin | ID3 | Gangopadhyay et al., 1985 |
| (GI) | | | |
| Gallbladder, | high Mᵣ mucin | DU-PAN-2 | Lan et al., 1985 |
| Pancreas, | | | |
| Stomach | | | |
| Pancreas | NS | OV-TL3 | Poels et al., 1984 |
| Pancreas, | ‘TAG-72’ high Mᵣ mucin | B72-3 | Thor et al., 1986 |
| Stomach, | | | |
| Esophagus | | | |
| Stomach | ‘CEA’ 180 Kd GP | CEA 11-H5 | Wagener et al., 1984 |
| Pancreas | HMFG-2 > 400 Kd GP | 3-14-A3 | Burchell et al., 1983 |
| GI | NS | C COLI | Lemkin et al., 1984 |
| Pancreas, | CA 19-9 (or GICA) | CA-19-9 | Szymendera, 1986 |
| Stomach | | (1116NS 19-9) | |
| | | and CA50 | |
| Pancreas | CA125 GP | OC125 | Szymendera, 1986 |
| Lung | p185^{HER2} | 4D5, 3H4, 7C2, | Shepard et al., 1991 |
| Non-small-cell | | 6E9, 2C4, 7F3, | |
| lung cancer | | 2H11, 3E8, 5B8, | |
| (NSCLC) | | 7D3, SB8 | |
| NSCLC | high Mᵣ mucin/glycolipid | MO v2 | Miotti et al., 1985 |
| NSCLC | ‘TAG -72’ high Mᵣ mucin | B72-3 | Thor et al., 1986 |
| NSCLC | High Mᵣ mucin | DU-PAN-2 | Lan et al., 1985 |
| NSCLC | ‘CEA’ 180 kD GP | CEA 11-H5 | Wagener et al., 1984 |
| Malignant | Cytoplastic antigen that | MUG 8-22 | Stavrou, 1990 |
| Glioma | consists of 85HG-22 cells | | |
| Malignant | Cell surface Ag that | MUC 2-63 | Stavrou, 1990 |
| Glioma | consists of 85HG-\63 cells | | |
| Malignant | Cell surface Ag that | MUC 2-39 | Stavrou, 1990 |
| Glioma | consists of 86HG-39 cells | | |
| Malignant | Cell surface Ag that | MUG 7-39 | Stavrou, 1990 |
| Glioma | consists of 86HG-39 cells | | |
| GI, Other | P53 | PAb 240, PAb | Imperial Cancer |
| | | 246, PAb 1801 | Research Technology |
| | | | MaB Listing |
| Small, Round- | Neural cell adhesion | ERIC-1 | Imperial Cancer |
| Cell Tumors | molecules | | Research Technology |
| | | | MaB Listing |
| Medulloblas- | | M148 | Imperial Cancer |
| tomas, Neuro- | | | Research Technology |
| blastomas, | | | MaB Listing |
| Rhabdomyo- | | | |
| sarcomas | | | |
| Neuro- | | FMH25 | Imperial Cancer |
| blastomas | | | Research Technology |
| | | | MaB Listing |
| Kidneys & | P155 | 6-1 | Loop et al., 1981 |
| Glioblastomas | | | |
| Bladders & | “Ca Antigen” 350-390 kD | CA1 | Ashall et al., 1982 |
| Laryngeal | | | |
| Tumors | | | |
| Neuroblastoma | GD2 | 3F8 | Cheung et al., 1986 |
| Prostate | Gp48 48 kD GP | 4F₇/7A₁₀ | Bhattacharya et al., 1984 |
| Prostate | 60 kD GP | 2C₈/2F₇ | Bhattacharya et al., 1985 |
| Prostate | TMEFF2, TENB2, NC-2 | 2H8, 48G2 | WO 2003075855; |
| | | | Glynne-Jones et al., 2001 |
| Thyroid | ‘CEA’ 180 kD GP | CEA 11-H5 | Wagener et al., 1984 |

As especially preferred recognition units for treating hematological tumors, antibodies or antibody fragments, such as CD19, CD20, CD40, CD22, CD25, CD5, CD52, CD10, CD2, CD7, CD33, CD38, CD40, CD72, CD4, CD21, CD5, CD37 and CD30, can also be mentioned.

As especially preferred recognition units for anti-angiogenic therapy, antibodies or fragments thereof, such as VCAM, CD3 1, ELAM, endoglin, VEGFRI/II, VEGFRvIII, scFv(14E1), αᵥ,β₃, Tie ½, TES23 (CD44ex6), phosphatidylserine, PSMA, VEGFR/VEGF complex or ED-B-fibronectin, can also be mentioned.

The compounds that are mentioned below are especially preferred according to the invention as effector elements:
(4S,7R,8S,9S,13Z,16S(E))-4,8-Dihydroxy-5,5,7,9,13-pentamethyl-16-[1- methyl-2-(2-methyl-thiazol-4-yl)-vinyl]-oxacyclohexadec-13-ene-2,6-dione,
(4S,7R,8S,9S,13Z,16S(E))-4,8-Dihydroxy-16-[2-(2-hydroxymethyl-thiazol-4-yl)-1-methyl-vinyl]-5,5,7,9,13-pentamethyl-oxacyclohexadec-13-ene-2,6-dione,
(4S,7R,8S,9S,13Z,16S(E))-16-[2-(2-Aminomethyl-thiazol-4-yl)-1-methyl-vinyl]-4,8-dihydroxy-5,5,7,9,13-pentamethyl-oxacyclohexadec-13-ene-2,6-dione,
(1S,3S(E),7S,10R,11S,12S,16R)-7,11-Dihydroxy-8,8,10,12,16-pentamethyl-3-[1-methyl-2-(2-methyl-thiazol-4-yl)-vinyl]-4,17-dioxa-bicyclo [14.1.0]heptadecane-5,9-dione,
(1S,3S(E),7S,10R,11S,12S,16R)-7,11-Dihydroxy-3-[2-(2-hydroxymethyl-thiazol-4-yl)-1-methyl-vinyl]-8,8,10,12,16-pentamethyl-4,17-dioxa-bicyclo [14.1.0]-heptadecane-5,9-dione,
(1S,3S(E),7S,10R,11S,12S,16R)-3-[2-(2-Aminomethyl-thiazol-4-yl)-1-methyl-vinyl]-7,11-dihydroxy-8,8,10,12,16-pentamethyl-4,17-dioxa-bicyclo[14.1.0]-heptadecane-5,9-dione,
(4S,7R,8S,9S,13Z,16S(E))-4,8-Dihydroxy-7-ethyl-5,5,9,13-tetramethyl-16-[1-methyl-2-(2-methyl-thiazol-4-yl)-vinyl]-oxacyclohexadec-13-ene-2,6-dione,
(4S,7R,8S,9S,13Z,16S(E))-4,8-Dihydroxy-16-[2-(2-hydroxymethyl-thiazol-4-yl)-1-methyl-vinyl]-7-ethyl-5,5,9,13-tetramethyl-oxacyclohexadec-13-ene-2,6-dione,
(4S,7R,8S,9S,13Z,16S(E))-16-[2-(2-Aminomethyl-thiazol-4-yl)-1-methyl-vinyl]-4,8-dihydroxy-7-ethyl-5,5,9,13-tetramethyl-oxacyclohexadec-13-ene-2,6-dione,
(1S,3S(E),7S,10R,11S,12S,16R)-7,11-Dihydroxy-10-ethyl-8,8,12,16-tetramethyl-3-[1-methyl-2-(2-methyl-thiazol-4-yl)-vinyl]-4,17-dioxa-bicyclo [14.1.0]-heptadecane-5,9-dione;
(1S,3S(E),7S,10R,11S,12S,16R)-7,11-Dihydroxy-3-[2-(2-hydroxymethyl-thiazol-4-yl)-1-methyl-vinyl]-10-ethyl-8,8,12,16-tetramethyl-4,17-dioxa-bicyclo [14.1.0]heptadecane-5,9-dione;
(1S,3S(E),7S,10R,11S,12S,16R)-3-[2-(2-Aminomethyl-thiazol-4-yl)-1-methyl- vinyl]-7,11-dihydroxy-10-ethyl-8,8,12,16-tetramethyl-4,17-dioxa-bicyclo[14.1.0]-heptadecane-5,9-dione;
(4S,7R,8S,9S,13Z,16S(Z))-4,8-Dihydroxy-5,5,7,9,13-pentamethyl-16-[1-fluoro-2-(2-methyl-thiazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-thiazol-4-yl)-1-fluoro-vinyl]-5,5,7,9,13-pentamethyl-oxacyclohexadec-13-ene-2,6-dione;
(4S,7R,8S,9S,13Z,16S(Z))-16-[2-(2-Aminomethyl-thiazol-4-yl)-1-fluoro-vinyl]-4,8-dihydroxy-5,5,7,9,13-pentamethyl-oxacyclohexadec-13-ene-2,6-dione;
(1S,3S(Z),7S,10R,11S,12S,16R)-7,11-Dihydroxy-8,8,10,12,16-pentamethyl-3-[1-fluoro-2-(2-methyl-thiazol-4-yl)-vinyl]-4,17-dioxa-bicyclo [14.1.0]heptadecane-5,9-dione;
(1S,3S(Z),7S,10R,11S,12S,16R)-7, 11-Dihydroxy-3-[2-(2-hydroxymethyl-thiazol-4-yl)-1-fluoro-vinyl]-8,8,10,12,16-pentamethyl-4,17-dioxa-bicyclo[ 14.1.0]-heptadecane-5,9-dione;
(1S,3S(Z),7S,10R,11S,12S,16R)-3-[2-(2-Aminomethyl-thiazol-4-yl)--1-fluoro- vinyl]-7,11-dihydroxy-8,8,10,12,16-pentamethyl-4,17-dioxa-bicyclo[14.1.0]-heptadecane-5,9-dione;
(4S,7R,8S,9S,13Z,16S(Z))-4,8-Dihydroxy-5,5,7,9,13-pentamethyl-16-[1-chloro-2-(2-methyl-thiazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-thiazol-4-yl)-1-chloro-vinyl]-5,5,7,9,13-pentamethyl-oxacyclohexadec-13-ene-2,6-dione;
(4S,7R,8S,9S,13Z,16S(Z))-16-[2-(2-Aminomethyl-thiazol-4-yl)-1-chloro-vinyl]-4,8-dihydroxy-5,5,7,9,13-pentamethyl-oxacyclohexadec-13-ene-2,6-dione;
(1S,3S(Z),7S,10R,11S,12S,16R)-7,11-Dihydroxy-8,8,10,12,16-pentamethyl-3-[1-chloro-2-(2-methyl-thiazol-4-yl)-vinyl]-4,17-dioxa-bicyclo[14.1.0]heptadecane-5,9-dione;
(1S,3 S(Z),7S,10R,11S,12S,16R)-7,11-Dihydroxy-3-[2-(2-hydroxymethyl-thiazol-4-yl)-1-chloro-vinyl]-8,8,10,12,16-pentamethyl-4,17-dioxa-bicyclo[14.1.0]-heptadecane-5,9-dione;
(1S,3S(Z),7S,10R,11S,12S,16R)-3-[2-(2-Aminomethyl-thiazol-4-yl)-1-chloro- vinyl]-7,11-dihydroxy-8,8,10,12,16-pentamethyl-4,17-dioxa-bicyclo[14.1.0]-heptadecane-5,9-dione;

(4S,7R,8S,9S,13Z,16S(Z))-4,8-Dihydroxy-7-ethyl-5,5,9,13-tetramethyl-16-[1-fluoro-2-(2-methyl-thiazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-thiazol-4-yl)-1-fluoro-vinyl]-7-ethyl-5,5,9,13-tetramethyl-oxacyclohexadec-13-ene-2,6-dione;
(4S,7R,8S,9S,13Z,16S(Z))-16-[2-(2-Aminomethyl-thiazol-4-yl)-1-fluoro-vinyl]-4,8-dihydroxy-7-ethyl-5,5,9,13-tetramethyl-oxacyclohexadec-13-ene-2,6-dione;
(1S,3S(Z),7S,10R,11S,12S,16R)-7,11-Dihydroxy-10-ethyl-8,8,12,16-tetramethyl-3-[1-fluoro-2-(2-methyl-thiazol-4-yl)-vinyl]-4,17-dioxa-bicyclo[14.1.0]-heptadecane-5,9-dione;
(1S,3S(Z),7S,10R,11S,12S,16R)-7, 11-Dihydroxy-3-[2-(2-hydroxymethyl-thiazol-4-yl)-1-fluoro-vinyl]-10-ethyl-8,8,12,16-tetramethyl-4,17-dioxa-bicyclo[14.1.0]-heptadecane-5,9-dione;
(1S,3S(Z),7S,10R,11S,12S,16R)-3-[2-(2-Aminomethyl-thiazol-4-yl)-1-fluoro-vinyl]-7,11-dihydroxy-10ethyl-8,8,12,16-tetramethyl-4,17-dioxa-bicyclo[14.1.0]-heptadecane-5,9-dione;
(4S,7R,8S,9S,13Z,16S(Z))-4,8-Dihydroxy-7-ethyl-5,5,9,13-tetramethyl-16-[1-chloro-2-(2-methyl-thiazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-thiazol-4-yl)-1-chloro-vinyl]-7-ethyl-5,5,9,13-tetramethyl-oxacyclohexadec-13-ene-2,6-dione;
(4S,7R,8S,9S,13Z,16S(Z))-16-[2-(2-Aminomethyl-thiazol-4-yl)-1-chloro-vinyl]-4,8-dihydroxy-7-ethyl-5,5,9,13-tetramethyl-oxacyclohexadec-13-ene-2,6-dione;
(1S,3S(Z),7S,10R,11S,12S,16R)-7,11-Dihydroxy-10-ethyl-8,8,12,16-tetramethyl-3-[1-chloro-2-(2-methyl-thiazol-4-yl)-vinyl]-4,17-dioxa-bicyclo[14.1.0]-heptadecane-5,9-dione;
(1S,3S(Z),7S,10R,11S,12S,16R)-7,11-Dihydroxy-3-[2-(2-hydroxymethyl-thiazol-4-yl)-1-chloro-vinyl]-10-ethyl-8,8,12,16-tetramethyl-4,17-dioxa-bicyclo[14.1.0]heptadecane-5,9-dione;
(1S,3S(Z),7S,10R,11S,12S,16R)-3-[2-(2-Aminomethyl-thiazol-4-yl)-1-chloro-vinyl]-7,11-dihydroxy-10-ethyl-8,8,12,16-tetramethyl-4,17-dioxa-bicyclo [14.1.0]-heptadecane-5,9-dione;
(4S,7R,8S,9S,13Z,16S(E))-4,8-Dihydroxy-5,5,7,9,13-pentamethyl-16-[1-methyl-2-(2-pyridyl)-vinyl]-oxacyclohexadec-13-ene-2,6-dione;
(1S,3S(E),7S,10R,11S,12S,16R)-7,11-Dihydroxy-8,8,10,12,16-pentamethyl-3-[1-methyl-2-(2-pyridyl)-vinyl]-4,17-dioxa-bicyclo[14.1.0]heptadecane-5,9-dione;
(4S,7R,8S,9S,13Z,16S(E))-4,8-Dihydroxy-7-ethyl-5,5,9,13-tetramethyl-16-[1-methyl-2-(2-pyridyl)-vinyl]-oxacyclohexadec-13-ene-2,6-dione;
(1S,3S(E),7S, 10R,11S,12S,16R)-7,11-Dihydroxy-10-ethyl-8,8,12,16-tetramethyl-3-[1-methyl-2-(2-pyridyl)-vinyl]-4,17-dioxa-bicyclo[14.1.0]heptadecane-5,9-dione;
(4S,7R,8S,9S,13Z,16S(Z))-4,8-Dihydroxy-5,5,7,9,13-pentamethyl-16-[1-fluoro-2-(2-pyridyl)-vinyl]-oxacyclohexadec-13-ene-2,6-dione;
(1S,3S(Z),7S,10R,11S,12S,16R)-7,11-Dihydroxy-8,8,10,12,16-pentamethyl-3-[1-fluoro-2-(2-pyridyl)-vinyl]-4,17-dioxa-bicyclo[14.1.0]heptadecane-5,9-dione;
(4S,7R,8S,9S,13Z,16S(Z))-4,8-Dihydroxy-5,5,7,9,13-pentamethyl-16-[1-chloro-2-(2-pyridyl)-vinyl]-oxacyclohexadec-13-ene-2,6-dione;
(1S,3S(Z),7S,10R,11S,12S,16R)-7, 11-Dihydroxy-8,8,10,12,16-pentamethyl-3-[1-chloro-2-(2-pyridyl)-vinyl]-4,17-dioxa-bicyclo[14.1.0]heptadecane-5,9-dione;
(4S,7R,8S,9S,13Z,16S(Z))-4,8-Dihydroxy-7-ethyl-5,5,9,13-tetramethyl-16-[1-fluoro-2-(2-pyridyl)-vinyl]-oxacyclohexadec-13-ene-2,6-dione;
(1S,3S(Z),7S,10R,11S,12S,16R)-7,11-Dihydroxy-10-ethyl-8,8,12,16-tetramethyl-3-[1-fluoro-2-(2-pyridyl)-vinyl]-4,17-dioxa-bicyclo[14.1.0]heptadecane-5,9-dione;
(4S,7R,8S,9S,13Z,16S(Z))-4,8-Dihydroxy-7-ethyl-5,5,9,13-tetramethyl-16-[1-chloro-2-(2-pyridyl)-vinyl]-oxacyclohexadec-13-ene-2,6-dione;
(1S,3 S(Z),7S,10R,11S,12S,16R)-7,11-Dihydroxy-10-ethyl-8,8,12,16-tetramethyl-3-[1-chloro-2-(2-pyridyl)-vinyl]-4,17-dioxa-bicyclo[14.1.0]heptadecane-5,9-dione;
(4S,7R,8S,9S,13Z,16S(E))-4,8-Dihydroxy-5,5,7,9,13-pentamethyl-16-[1-methyl-2-(2-methyl-oxazol-4-yl)-vinyl]-oxacyclohexadec-13-ene-2,6-dione;
(4S,7R,8S,9S,13Z,16S(E))-4,8-Dihydroxy-16-[2-(2-hydroxymethyl-oxazol-4-yl)-1-methyl-vinyl]-5,5,7,9,13-pentamethyl-oxacyclohexadec-13-ene-2,6-dione;
(4S,7R,8S,9S,13Z,16S(E))-16-[²-(2-Aminomethyl-oxazol-4-yl)-1-methyl-vinyl]-4,8-dihydroxy-5,5,7,9,13-pentamethyl-oxacyclohexadec-13-ene-2,6-dione;
(1S,3S(E),7S,10R,11S,12S,16R)-7,11-Dihydroxy-8,8,10,12,16-pentamethyl-3-[1-methyl-2-(2-methyl-oxazol-4-yl)-vinyl]-4,17-dioxa-bicyclo[14.1.0]heptadecane-5,9-dione;
(1S,3S(E),7S,10R,11S,12S,16R)-7, 11-Dihydroxy-3-[2-(2-hydroxymethyl-oxazol-4-yl)-1-methyl-vinyl]-8,8,10,12,16-pentamethyl-4,17-dioxa-bicyclo[14.1.0]-heptadecane-5,9-dione;
(1S,3S(E),7S,10R,11S,12S,16R)-3-[2-(2-Aminomethyl-oxazol-4-yl)-1-methyl-vinyl]-7,11-dihydroxy-8,8,10,12,16-pentamethyl-4,17-dioxa-bicyclo[14.1.0]-heptadecane-5,9-dione;

(4S,7R,8S,9S,13Z,16S(E))-4,8-Dihydroxy-7-ethyl-5,5,9,13-tetramethyl-16-[1-methyl-2-(2-methyl-oxazol-4-yl)-vinyl]-oxacyclohexadec-13-ene-2,6-dione;

(4S,7R,8S,9S,13Z,16S(E))-4,8-Dihydroxy-16-[2-(2-hydroxymethyl-oxazol-4-yl)-1-methyl-vinyl]-7-ethyl-5,5,9,13-tetramethyl-oxacyclohexadec-13-ene-2,6-dione;

(4S,7R,8S,9S,13Z,16S(E))-16-[2-(2-Aminomethyl-oxazol-4-yl)-1-methyl-vinyl]-4,8-dihydroxy-7-ethyl-5,5,9,13-tetramethyl-oxacyclohexadec-13-ene-2,6-dione;
(1S,3S(E),7S,10R,11S,12S,16R)-7,11-Dihydroxy-10-ethyl-8,8,12,16-tetramethyl-3-[1-methyl-2-(2-methyl-oxazol-4-yl)-vinyl]-4,17-dioxa-bicyclo[14.1.0]-heptadecane-5,9-dione;
(1S,3S(E),7S,10R,11S,12S,16R)-7,11-Dihydroxy-3-[2-(2-hydroxymethyl-oxazol-4-yl)-1-methyl-vinyl]-10-ethyl-8,8,12,16-tetramethyl-4,17-dioxa-bicyclo[14.1.0]heptadecane-5,9-dione;
(1S,3S(E),7S,10R,11S,12S,16R)-3-[2-(2-Aminomethyl-oxazol-4-yl)-1-methyl-vinyl]-7,11-dihydroxy-10-ethyl-8,8,12,16-tetramethyl-4,17-dioxa-bicyclo[14.1.0]-heptadecane-5,9-dione;
(4S,7R,8S,9S,13Z,16S(Z))-4,8-Dihydroxy-5,5,7,9,13-pentamethyl-16-[1-fluoro-2-(2-methyl-oxazol-4-yl)-vinyl]-oxacyclohexadec-13-ene-2,6-dione;

(4S,7R,8S,9S,13Z,16S(Z))-4,8-Dihydroxy-16-[2-(2-hydroxymethyl-oxazol-4-yl)-1-fluoro-vinyl]-5,5,7,9,13-pentamethyl-oxacyclohexadec-13-ene-2,6-dione;
(4S,7R,8S,9S,13Z,16S(Z))-16-[2-(2-Aminomethyl-oxazol-4-yl)-1-fluoro-vinyl]-4,8-dihydroxy-5,5,7,9,13-pentamethyl-oxacyclohexadec-13-ene-2,6-dione;
(1S,3S(Z),7S,10R,11S,12S,16R)-7,11-Dihydroxy-8,8,10,12,16-pentamethyl-3-[1-fluoro-2-(2-methyl-oxazol-4-yl)-vinyl]-4,17-dioxa-bicyclo[14.1.0]heptadecane-5,9-dione;
(1S,3S(Z),7S,10R,11S,12S,16R)-7,11-Dihydroxy-3-[2-(2-hydroxymethyl-oxazol-4-yl)-1-fluoro-vinyl]-8,8,10,12,16-pentamethyl-4,17-dioxa-bicyclo[14.1.0]-heptadecane-5,9-dione;
(1S,3S(Z),7S,10R,11S,12S,16R)-3-[2-(2-Aminomethyl-oxazol-4-yl)-1-fluoro-vinyl]-7,11-dihydroxy-8,8,10,12,16-pentamethyl-4,17-dioxa-bicyclo[14.1.0]-heptadecane-5,9-dione;
(4S,7R,8S,9S,13Z,16S(Z))-4,8-Dihydroxy-5,5,7,9,13-pentamethyl-16-[1-chloro-2-(2-methyl-oxazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-oxazol-4-yl)-1-chloro-vinyl]-5,5,7,9,13-pentamethyl-oxacyclohexadec-13-ene-2,6-dione;
(4S,7R,8S,9S,13Z,16S(Z))-16-[2-(2-Aminomethyl-oxazol-4-yl)-1-chloro-vinyl]-4,8-dihydroxy-5,5,7,9,13-pentamethyl-oxacyclohexadec-13-ene-2,6-dione;
(1S,3S(Z),7S,10R,11S,12S,16R)-7,11-Dihydroxy-8,8,10,12,16-pentamethyl-3-[1-chloro-2-(2-methyl-oxazol-4-yl)-vinyl]-4,17-dioxa-bicyclo[14.1.0]heptadecane-5,9-dione;
(1S,3S(Z),7S,10R,11S,12S,16R)-7,11-Dihydroxy-3-[2-(2-hydroxymethyl-oxazol-4-yl)-1-chloro-vinyl]-8,8,10,12,16-pentamethyl-4,17-dioxa-bicyclo[14.1.0]-heptadecane-5,9-dione;
(1S,3S(Z),7S,10R,11S,12S,16R)-3-[2-(2-Aminomethyl-oxazol-4-yl)-1-chloro-vinyl]-7,11-dihydroxy-8,8,10,12,16-pentamethyl-4,17-dioxa-bicyclo[14.1.0]-heptadecane-5,9-dione;
(4S,7R,8S,9S,13Z,16S(Z))-4,8-Dihydroxy-7-ethyl-5,5,9,13-tetramethyl-16-[1-fluoro-2-(2-methyl-oxazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-oxazol-4yl)-1-fluoro-vinyl]-7-ethyl-5,5,9,13-tetramethyl-oxacyclohexadec-13-ene-2,6-dione;
(4S,7R,8S,9S,13Z,16S(Z))-16-[2-(2-Aminomethyl-oxazol-4-yl)-1-fluoro-vinyl]-4,8-dihydroxy-7-ethyl-5,5,9,13-tetramethyl-oxacyclohexadec-13-ene-2,6-dione;
(1S,3S(Z),7S,10R,11S,12S,16R)-7,11-Dihydroxy-10-ethyl-8,8,12,16-tetramethyl-3-[1-fluoro-2-(2-methyl-oxazol-4-yl)-vinyl]-4,17-dioxa-bicyclo[14.1.0]-heptadecane-5,9-dione;
(1S,3S(Z),7S,10R,11S,12S,16R)-7, 11-Dihydroxy-3-[2-(2-hydroxymethyl-oxazol-4-yl)-1-fluoro-vinyl]-10-ethyl-8,8,12,16-tetramethyl-4,17-dioxa-bicyclo[14.1.0]heptadecane-5,9-dione;
(1S,3S(Z),7S,10R,11S,12S,16R)-3-[2-(2-Aminomethyl-oxazol-4-yl)-1-fluoro- vinyl]-7,11-dihydroxy-10-ethyl-8,8,12,16-tetramethyl-4,17-dioxa-bicyclo[14.1.0]-heptadecane-5,9-dione;
(4S,7R,8S,9S,13Z,16S(Z))-4,8-Dihydroxy-7-ethyl-5,5,9,13-tetramethyl-16-[1-chloro-2-(2-methyl-oxazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-oxazol-4-yl)-1-chloro-vinyl]-7-ethyl-5,5,9,13-tetramethyl-oxacyclohexadec-13-ene-2,6-dione;
(4S,7R,8S,9S,13Z,16S(Z))-16-[2-(2-Aminomethyl-oxazol-4-yl)-1-chloro-vinyl]-4,8-dihydroxy-7-ethyl-5,5,9,13-tetramethyl-oxacyclohexadec-13-ene-2,6-dione;
(1S,3S(Z),7S,10R,11S,12S,16R)-7,11-Dihydroxy-10-ethyl-8,8,12,16-tetramethyl-3-[1-chloro-2-(2-methyl-oxazol-4-yl)-vinyl]-4,17-dioxa-bicyclo[14.1.0]-heptadecane-5,9-dione;
(1S,3S(Z),7S,10R,11S,12S,16R)-7, 11-Dihydroxy-3-[2-(2-hydroxymethyl-oxazol-4-yl)-1-chloro-vinyl]-10-ethyl-8,8,12,16-tetramethyl-4,17-dioxa-bicyclo[14.1.0]-heptadecane-5,9-dione;
(1S,3S(Z),7S,10R,11S,12S,16R)-3-[2-(2-Aminomethyl-oxazol-4-yl)-1-chloro-vinyl]-7,11-dihydroxy-10-ethyl-8,8,12,16-tetramethyl-4,17-dioxa-bicyclo[14.1.0]-heptadecane-5,9-dione;
(4S,7R,8S,9S,13Z,16S(E))-4,8-Dihydroxy-5,5,7,9,13-pentamethyl-16-[2-(2-methyl-thiazol-4-yl)-vinyl]-oxacyclohexadec-13-ene-2,6-dione;

(4S,7R,8S,9S,13Z,16S(E))-4,8-Dihydroxy-16-[2-(2-hydroxymethyl-thiazol-4-yl)-vinyl]-5,5,7,9,13-pentamethyl-oxacyclohexadec-13-ene-2,6-dione;
(4S,7R,8S,9S,13Z,16S(E))-16-[2-(2-Aminomethyl-thiazol-4-yl)-vinyl]-4,8-dihydroxy-5,5,7,9,13-pentamethyl-oxacyclohexadec-13-ene-2,6-dione;
(1S,3S(E),7S,10R,11S,12S,16R)-7,11-Dihydroxy-8,8,10,12,16-pentamethyl-3-[2-(2-methyl-thiazol-4-yl)-vinyl]-4,17-dioxa-bicyclo[14.1.0]heptadecane-5,9-dione;
(1S,3S(E),7S,10R,11S,12S,16R)-7,11-Dihydroxy-3-[2-(2-hydroxymethyl-thiazol-4-yl)-vinyl]-8,8,10,12,16-pentamethyl-4,17-dioxa-bicyclo[14.1.0]heptadecane-5,9-dione;
(1S,3S(E),7S,10R,11S,12S,1⁶R)-3-[2-(2-Aminomethyl-thiazol-4-yl)-vinyl]-7,11-dihydroxy-8,8,10,12,16-pentamethyl-4,17-dioxa-bicyclo[14.1.0]heptadecane-5,9-dione;
(4S,7R,8S,9S,13Z,16S(E))-4,8-Dihydroxy-7-ethyl-5,5,9,13-tetramethyl-16-[2-(2-methyl-thiazol-4-yl)-vinyl]-oxacyclohexadec-13-ene-2,6-dione;
(4S,7R,8S,9S,13Z,16S(E))-4,8-Dihydroxy-16-[2-(2-hydroxymethyl-thiazol-4-yl)-vinyl]-7-ethyl-5,5,9,13-tetramethyl-oxacyclohexadec-13-ene-2,6-dione;
(4S,7R,8S,9S,13Z,16S(E))-16-[2-(2-Aminomethyl-thiazol-4-yl)-vinyl]-4,8-dihydroxy-7-ethyl-5,5,9,13-tetramethyl-oxacyclohexadec-13-ene-2,6-dione;
(1S,3S(E),7S,10R,11S,12S,16R)-7,11-Dihydroxy-10-ethyl-8,8,12,16-tetramethyl-3-[2-(2-methyl-thiazol-4-yl)-vinyl]-4,17-dioxa-bicyclo[14.1.0]heptadecane-5,9-dione;
(1S,3S(E),7S,10R,11S,12S,16R)-7, 11-Dihydroxy-3-[2-(2-hydroxymethyl-thiazol-4-yl)-vinyl]-10-ethyl-8,8,12,16-tetramethyl-4,17-dioxa-bicyclo[14.1.0]-heptadecane-5,9-dione;
(1S,3S(E),7S,10R,11S,12S,16R)-3-[2-(2-Aminomethyl-thiazol-4-yl)-vinyl]-7,11-dihydroxy-10-ethyl-8,8,12,16-tetramethyl-4,17-dioxa-bicyclo[14.1.0]heptadecane-5,9-dione;
(4S,7R,8S,9S,13Z,16S(E))-4,8-Dihydroxy-5,5,7,9,13-pentamethyl-16-[2-(2-pyridyl)-vinyl]-oxacyclohexadec-13-ene-2,6-dione;
(1S,3S(E),7S,10R,11S,12S,16R)-7,11-Dihydroxy-8,8,10,12,16-pentamethyl-3-[2-(2-pyridyl)-vinyl]-4,17-dioxa-bicyclo[14.1.0]heptadecane-5,9-dione;
(4S,7R,8S,9S,13Z,16S(E))-4,8-Dihydroxy-7-ethyl-5,5,9,13-tetramethyl-16-[2(2-pyridyl)-vinyl]-oxacyclohexadec-13-ene-2,6-dione;
(1S,3S(E),7S,10R,11S,12S,16R)-7,11-Dihydroxy-10-ethyl-8,8,12,16-tetramethyl-3-[2-(2-pyridyl)-vinyl]-4,17-dioxa-bicyclo[14.1.0]heptadecane-5,9-dione;
(4S,7R,8S,9S,13Z,16S)-4,8-Dihydroxy-5,5,7,9,13-pentamethyl-16-(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-5,5,7,9,13-pentamethyl-oxacyclohexadec-13-ene-2,6-dione;
(4S,7R,8S,9S,13Z,16S)-16-(2-Aminomethyl-benzothiazol-5-yl)-4,8-dihydroxy-5,5,7,9,13-pentamethyl-oxacyclohexadec-13-ene-2,6-dione;
(1S,3S,7S,10R,11S,12S,16R)-7,11-Dihydroxy-8,8,10,12,16-pentamethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-8,8,10,12,16-pentamethyl-4,17-dioxa-bicyclo[14.1.0]heptadecane-5,9-dione;
(1S,3S,7S,10R,11S,12S,16R)-3-(2-Aminomethyl-benzothiazol-5-yl)-7,11dihydroxy-8,8,10,12,16-pentamethyl-4,17-dioxa-bicyclo[14.1.0]heptadecane-5,9-dione;
(4S,7R,8S,9S,13Z,16S)-4,8-Dihydroxy-7-ethyl-5,5,9,13-tetramethyl-16-(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-7-ethyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-ethyl-5,5,9,13-tetramethyl-oxacyclohexadec-13-ene-2,6-dione;
(1S,3S,7S,10R,11S,12S,16R)-7,11-Dihydroxy-10-ethyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-ethyl-8,8,12,16-tetramethyl-4,17-dioxa-bicyclo[14.1.0]-heptadecane-5,9-dione;
(1S,3S,7S,10R,11S,12S,16R)-3-(2-Aminomethyl-benzothiazol-5-yl)-7,11-dihydroxy-10-ethyl-8,8,12,16-tetramethyl-4,17-dioxa-bicyclo[14.1.0]heptadecane-5,9-dione;
(4S,7R,8S,9S,13Z,16S)-4,8-Dihydroxy-7-propyl-5,5,9,13-tetramethyl-16-(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-7-propyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-propyl-5,5,9,13-tetramethyl-oxacyclohexadec-13-ene-2,6-dione;
(1S,3S,7S,10R,11S,12S,16R)-7,11-Dihydroxy-10-propyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-propyl-8,8,12,16-tetramethyl-4,17-dioxa-bicyclo[14.1.0]-heptadecane-5,9-dione;
(1S,3S,7S,10R,11S,12S,16R)-3-(2-Aminomethyl-benzothiazol-5-yl)-7,11-dihydroxy-10-propyl-8,8,12,16-tetramethyl-4,17-dioxa-bicyclo[14.1.0]heptadecane-5,9-dione;
(4S,7R,8S,9S,13Z,16S)-4,8-Dihydroxy-7-butyl-5,5,9,13-tetramethyl-16-(2-methyl-benzothiazol-5-yl)-oxacyclohexadec-13-ene-2,6-dione;
(4S,7R,8 S,9S,13Z,16S)-4,8-Dihydroxy-16-(2-hydroxymethyl-benzothiazol-5-yl)-7-butyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-butyl-5,5,9,13-tetramethyl-oxacyclohexadec-13-ene-2,6-dione;
(1S,3S,7S,10R,11S,12S,16R)-7,11-Dihydroxy-10-butyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-butyl-8,8,12,16-tetramethyl-4,17-dioxa-bicyclo[14.1.0]-heptadecane-5,9-dione;
(1S,3S,7S,10R,11S,12S,16R)-3-(2-Aminomethyl-benzothiazol-5-yl)-7,11-dihydroxy-10-butyl-8,8,12,16-tetramethyl-4,17-dioxa-bicyclo[14.1.0]heptadecane-5,9-dione;
(4S,7R,8S,9S,13Z,16S)-4,8-Dihydroxy-7-allyl-5,5,9,13-tetramethyl-16-(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-7-allyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-allyl-5,5,9,13-tetramethyl-oxacyclohexadec-13-ene-2,6-dione;
(1S,3S,7S,10R,11S,12S,16R)-7,11-Dihydroxy-10-allyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-allyl-8,8,12,16-tetramethyl-4,17-dioxa-bicyclo[14.1.0]-heptadecane-5,9-dione;
(1S,3S,7S,10R,11S,12S,16R)-3-(2-Aminomethyl-benzothiazol-5-yl)-7,11-dihydroxy-10-allyl-8,8,12,16-tetramethyl-4,17-dioxa-bicyclo[14.1.0]heptadecane-5,9-dione;
(4S,7R,8S,9S,13Z,16S)-4,8-Dihydroxy-7-prop-2-inyl-5,5,9,13-tetramethyl-16-(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-7-prop-2-inyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-prop-2-inyl-5,5,9,13-tetramethyl-oxacyclohexadec-13-ene-2,6-dione;
(1S,3S,7S,10R,11S,12S,16R)-7,11-Dihydroxy-10-prop-2-inyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-prop-2-inyl-8,8,12,16-tetramethyl-4,17-dioxa-bicyclo[14.1.0]-heptadecane-5,9-dione;
(1S,3S,7S,10R,11S,12S,16R)-3-(2-Aminomethyl-benzothiazol-5-yl)-7,11-dihydroxy-10-prop-2-inyl-8,8,12,16-tetramethyl-4,17-dioxa-bicyclo[14.1.0]-heptadecane-5,9-dione;
(4S,7R,8S,9S,13Z,16S)-4,8-Dihydroxy-7-but-3-enyl-5,5,9,13-tetramethyl-16-(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-7-but-3-enyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-but-3-enyl-5,5,9,13-tetramethyl-oxacyclohexadec-13-ene-2,6-dione;
(1S,3S,7S,10R,11S,12S,16R)-7,11-Dihydroxy-10-but-3-enyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-but-3-enyl-8,8,12,16-tetramethyl-4,17-dioxa-bicyclo[14.1.0]-heptadecane-5,9-dione;
(1S,3S,7S,10R,11S,12S,16R)-3-(2-Aminomethyl-benzothiazol-5-yl)-7,11-dihydroxy-10-but-3-enyl-8,8,12,16-tetramethyl-4,17-dioxa-bicyclo[14.1.0]heptadecane-5,9-dione;
(4S,7R,8S,9S,13Z,16S)-4,8-Dihydroxy-7-but-3-inyl-5,5,9,13-tetramethyl-16-(2- methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-7-but-3-inyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-but-3-inyl-5,5,9,13-tetramethyl-oxacyclohexadec-13-ene-2,6-dione;
(1S,3S,7S,10R,11S,12S,16R)-7,11-Dihydroxy-10-but-3-inyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-but-3-inyl-8,8,12,16-tetramethyl-4,17-dioxa-bicyclo[14.1.0]-heptadecane-5,9-dione;
(1S,3S,7S,10R,11S,12S,16R)-3-(2-Aminomethyl-benzothiazol-5-yl)-7,11-dihydroxy-10-but-3-inyl-8,8,12,16-tetramethyl-4,17-dioxa-bicyclo[14.1.0]heptadecane-5,9-dione;
(4S,7R,8S,9S,13Z,16S)-4,8-Dihydroxy-5,5,7,9,13-pentamethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-5,5,7,9,13-pentamethyl-oxacyclohexadec-13-ene-2,6-dione;
(4S,7R,8S,9S,13Z,16S)-16-(2-Aminomethyl-benzoxazol-5-yl)-4,8-dihydroxy-5,5,7,9,13-pentamethyl-oxacyclohexadec-13-ene-2,6-dione;
(1S,3S,7S,10R,11S,12S,16R)-7,11-Dihydroxy-8,8,10,12,16-pentamethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-8,8,10,12,16-pentamethyl-4,17-dioxa-bicyclo[1 4.1.0]heptadecane-5,9-dione;
(1S,3S,7S,10R,11S,12S,16R)-3-(2-Aminomethyl-benzoxazol-5-yl)-7,11-dihydroxy-8,8,10,12,16-pentamethyl-4,17-dioxa-bicyclo[14.1.0]heptadecane-5,9-dione;
(4S,7R,8S,9S,13Z,16S)-4,8-Dihydroxy-7-ethyl-5,5,9,13-tetramethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-7-ethyl-5,5,9,13-tetramethyl-oxacyclohexadec-13-ene-2,6-dione;
(4S,7R,8S,9S,13Z,16S)-16-(2-Aminomethyl-benzoxazol-5-yl)-4,8-dihydroxy-7-ethyl-5,5,9,13-tetramethyl-oxacyclohexadec-13-ene-2,6-dione;
(1S,3S,7S,10R,11S,12S,16R)-7,11-Dihydroxy-10-ethyl-8,8,12,16-tetramethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-ethyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10-ethyl-8,8,12,16-tetramethyl-4,17-dioxa-bicyclo[14.1.0]heptadecane-5,9-dione;
(4S,7R,8S,9S,13Z,16S)-4,8-Dihydroxy-7-propyl-5,5,9,13-tetramethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-7-propyl-5,5,9,13-tetramethyl-oxacyclohexadec-13-ene-2,6-dione;
(4S,7R,8S,9S,13Z,16S)-16-(2-Aminomethyl-benzoxazol-5-yl)-4,8-dihydroxy-7-propyl-5,5,9,13-tetramethyl-oxacyclohexadec-13-ene-2,6-dione;
(1S,3S,7S,10R,11S,12S,16R)-7,11-Dihydroxy-10-propyl-8,8,12,16-tetramethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-propyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10-propyl-8,8,12,16-tetramethyl-4,17-dioxa-bicyclo[1 4.1.0]heptadecane-5,9-dione;
(4S,7R,8S,9S,13Z,16S)-4,8-Dihydroxy-7-butyl-5,5,9,13-tetramethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-7-butyl-5,5,9,13-tetramethyl-oxacyclohexadec-13-ene-2,6-dione;
(4S,7R,8S,9S,13Z,16S)-16-(2-Aminomethyl-benzoxazol-5-yl)-4,8-dihydroxy-7-butyl-5,5,9,13-tetramethyl-oxacyclohexadec-13-ene-2,6-dione;
(1S,3S,7S,10R,11S,12S,16R)-7,11-Dihydroxy-10-butyl-8,8,12,16-tetramethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-butyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10-butyl-8,8,12,16-tetramethyl-4,17-dioxa-bicyclo[14.1.0]heptadecane-5,9-dione;
(4S,7R,8S,9S,13Z,16S)-4,8-Dihydroxy-7-allyl-5,5,9,13-tetramethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-7-allyl-5,5,9,13-tetramethyl-oxacyclohexadec-13-ene-2,6-dione;
(4S,7R,8S,9S,13Z,16S)-16-(2-Aminomethyl-benzoxazol-5-yl)-4,8-dihydroxy-7-allyl-5,5,9,13-tetramethyl-oxacyclohexadec-13-ene-2,6-dione;
(1S,3S,7S,10R,11S,12S,16R)-7,11-Dihydroxy-10-allyl-8,8,12,16-tetramethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-allyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10allyl-8,8,12,16-tetramethyl-4,17-dioxa-bicyclo[14.1.0]heptadecane-5,9-dione;
(4S,7R,8S,9S,13Z,16S)-4,8-Dihydroxy-7-prop-2-inyl-5,5,9,13-tetramethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-7-prop-2-inyl-5,5,9,13-tetramethyl-oxacyclohexadec-13-ene-2,6-dione;
(4S,7R,8S,9S,13Z,16S)-16-(2-Aminomethyl-benzoxazol-5-yl)-4,8-dihydroxy-7-prop-2-inyl-5,5,9,13-tetramethyl-oxacyclohexadec-13-ene-2,6-dione;
(1S,3S,7S,10R,11S,12S,16R)-7,11-Dihydroxy-10-prop-2-inyl-8,8,12,16-tetramethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-prop-2-inyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10-prop-2-inyl-8,8,12,16-tetramethyl-4,17-dioxa-bicyclo[14.1.0]-heptadecane-5,9-dione;
(4S,7R,8S,9S,13Z,16S)-4,8-Dihydroxy-7-but-3-enyl-5,5,9,13-tetramethyl-16-(2- methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-7-but-3-enyl-5,5,9,13-tetramethyl-oxacyclohexadec-13-ene-2,6-dione;
(4S,7R,8S,9S,13Z,16S)-16-(2-Aminomethyl-benzoxazol-5-yl)-4,8-dihydroxy-7-but-3-enyl-5,5,9,13-tetramethyl-oxacyclohexadec-13-ene-2,6-dione;
(1S,3S,7S,10R,11S,12S,16R)-7,11-Dihydroxy-10-but-3-enyl-8,8,12,16-tetramethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-but-3-enyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10-but-3-enyl-8,8,12,16-tetramethyl-4,17-dioxa-bicyclo[14.1.0]heptadecane-5,9-dione;
(4S,7R,8S,9S,13Z,16S)-4,8-Dihydroxy-7-but-3-inyl-5,5,9,13-tetramethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-7-but-3-inyl-5,5,9,13-tetramethyl-oxacyclohexadec-13-ene-2,6-dione;
(4S,7R,8S,9S,13Z,16S)-16-(2-Aminomethyl-benzoxazol-5-yl)-4,8-dihydroxy-7-but-3-inyl-5,5,9,13-tetramethyl-oxacyclohexadec-13-ene-2,6-dione;
(1S,3S,7S,10R,11S,12S,16R)-7,11-Dihydroxy-10-but-3-inyl-8,8,12,16-tetramethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-but-3-inyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10-but-3-inyl-8,8,12,16-tetramethyl-4,17-dioxa-bicyclo[14.1.0]heptadecane-5,9-dione.

In a compound of general formula (I) according to the invention that contains one of the above-mentioned elements, the hydrogen atoms in the above-mentioned elements are replaced by radicals L¹-L³ in the positions that are indicated in formula (I), whereby radicals L¹-L³ have the above-indicated meanings.

The invention also relates to linkers of general formula III¹: 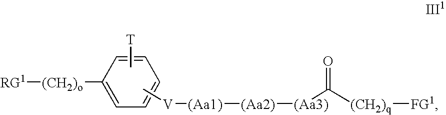
in which
RG¹ can be an O═C═N group, and o, T, V, Aa1, Aa2, Aa3, q and FG¹ have the already mentioned meanings,
   as well as linkers of general formula III² 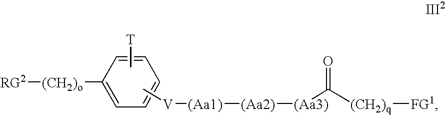
   in which
RG² is a Hal-C(═O)—CHR²² group or a Hal-C(═O)—CHR²²—NR²³—C(═O) group or an R²⁶—C(═O)—O—C(═O)—CHR²² group or an R²⁶—C(═O)—O—C(═O)—CHR²²—NR²³—C(═O) group, whereby R²⁶ is C₁-C₁₀ alkyl, aryl, or aralkyl, and o, V, q, T, Aa1, Aa2, Aa3 and FG¹ have the meanings that are mentioned in claim 1;
   as well as linkers of general formula III³ 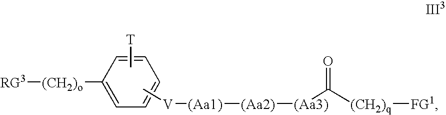
   in which
RG³ can be an OH group or an NHR^{24a} group or a COOH group, and o, T, V, Aa1, Aa2, Aa3, q and FG¹ have the meanings that were already mentioned above.

Especially preferred according to the invention are linkers of general formulas III¹, III², or III³, whereby Aa1 represents a bond.

The invention also relates to processes
for reacting a linker of general formula III¹
with a compound of general formula I, in which the condition that at least one group L¹, L² or L⁴ represent a linker need not be met, and in which L¹ and/or L² and/or L⁴ have the meaning of a hydrogen atom, and free hydroxyl groups and/or amino groups that are not required for the reaction optionally are protected,
for reacting a linker of general formula III²
with a compound of general formula I, in which the condition that at least one group L¹, L² or L⁴ represent a linker need not be met, and in which L¹ and/or L² and/or L⁴ have the meaning of a hydrogen atom, and free hydroxyl groups and/or amino groups that are not required for the reaction are optionally protected,
for reacting a linker of general formula III³
with a compound of general formula I, in which the condition that at least one group L¹, L² or L⁴ represent a linker need not be met, and L¹ and/or L² and/or L⁴ have the meaning of a C(═O)Hal group, and free hydroxyl groups and/or amino groups that are not required for the reaction are optionally protected.

The invention also relates to the use of a compound of general formula I, whereby the substituents have the above-mentioned meanings, but the condition that at least one substituent L¹, L² or L⁴ represent a linker of general formula III need not be met, and at least one substituent L¹, L² or L⁴ represents hydrogen or a group C(═O)Cl in a process as described above.

The invention also relates to the use of a compound of general formula I, whereby the substituents have the above-mentioned meanings, but the condition that at least one substituent L¹, L² or L⁴ represent a linker of general formula III need not be met, and at least one substituent L¹, L² or L⁴ represents hydrogen or a group C(═O)Cl for the production of an effector-recognition unit conjugate as described above.

The invention also relates to the use of a linker of general formula III¹, III² or III3 for the production of an effector conjugate, as described above.

The invention also relates to the use of a linker of general formula III¹, III² or III³ for the production of an effector-recognition unit conjugate as described above.

The invention also relates to the use of a recognition unit, as described above, in one of the processes according to the invention for the production of an effector-recognition unit conjugate, as described above.

The invention also relates to the effector-recognition unit conjugates according to the invention for use as medications or for the production of a medication or a pharmaceutical composition.

Finally, the invention relates to the use of the effector-recognition unit conjugates according to the invention for the production of medications for the treatment of diseases that are linked with proliferative processes, such as tumors, inflammatory and/or neurodegenerative diseases, multiple sclerosis, Alzheimer's disease, or for the treatment of angiogenesis-associated diseases, such as the growth of tumors, rheumatoid arthritis, or diseases of the ocular fundus.

### EXAMPLES OF SYNTHESIS OF LINKERS (L)

### Example L1

### (2S,5S)-[5-{2-[11-(2,5-Dioxo-2,5-dihydro-pyrrol-1-yl)-undecanoylamino]-3-phenyl-propionylamino}-5-(4-hydroxymethyl-phenylcarbamoyl)-pentyl]-carbamic acid allyl ester

### Example L1a

### 11-(2,5-Dioxo-2,5-dihydro-pyrrol-1-yl)-undecanoyl chloride

2.0 g (7.11 mmol) of 11-(2,5-dioxo-2,5-dihydro-pyrrol-1-yl)-undecanoic acid is mixed with 15.5 ml of thionyl chloride and refluxed for 15 minutes. After cooling, it is mixed with toluene and evaporated to the dry state. 2.13 g (max. 7.11 mmol) of the title compound, which is further reacted without purification, is isolated.

### Example L1b

### (S)-2-[11-(2,5-Dioxo-2,5-dihydro-pyrrol-1-yl)-undecanoylamino]-3-phenyl-propionic acid

The solution of 2.13 g (max. 7.11 mmol) of the compound, produced according to Example L1a, in 20 ml of dichloromethane is added in drops to the solution of 1.08 g of L-phenylalanine in 20 ml of pyridine within 10 minutes at 0° C. It is allowed to heat to 23° C. and stirred for 1.5 more hours. It is poured into water, set at a pH of 4 to 5 by adding a 4M hydrochloric acid solution and extracted several times with dichloromethane. The combined organic extracts are washed with water and saturated sodium chloride solution and dried on sodium sulfate. The residue that is obtained after filtration and removal of the solvent is purified by chromatography. 1.34 g (3.13 mmol, 44%) of the title compound is isolated.

### Example L1c

### (S)-6-Allyloxycarbonylamino-2-(9H-fluoren-9-ylmethoxycarbonylamino)-hexanoic acid

The solution of 25 g (61.7 mmol) of (S)-6-amino-2-(9H-fluoren-9-ylmethoxycarbonylamino)-hexanoic acid in 275 ml of dioxane is mixed with 25 ml of a 25% potassium carbonate solution, and 6.55 ml of allyl chloroformate is added. It is stirred for 20 hours at 23° C., diluted with water and extracted with methyl-tert-butyl ether. The separated aqueous phase is acidified with a 2N hydrochloric acid and extracted several times with dichloromethane. The combined dichloromethane phases are dried on sodium sulfate. After filtration and removal of the solvent, 26.3 g (58.1 mmol, 94%) of the title compound, which is further reacted without purification, is isolated.

### Example L1d

### (S)-[5-Allyloxycarbonylamino-1-(4-hydroxymethyl-phenylcarbamoyl)-pentyl]-carbamic acid 9H-fluoren-9-yl methyl ester

The solution of 7.24 g (16.0 mmol) of the compound, produced according to Example L1c, in 72 ml of pyridine is mixed with 1.97 g of 4-aminobenzyl alcohol, 3.68 ml of di-tert.-butyldicarbonate, and it is stirred for 16 hours at 23° C. It is concentrated by evaporation, mixed with toluene and concentrated by evaporation again. The residue is mixed with 150 ml of ethyl acetate, and the suspension is stirred for another 16 hours. It is suctioned off, the residue is rewashed with a little cold ethyl acetate and diethyl ether, and dried. 6.22 g (11.2 mmol, 70%) of the title compound is isolated as a colorless, amorphous solid.

### Example L1e

### (S)-[5-Amino-5-(4-hydroxymethyl-phenylcarbamoyl)-pentyl]-carbamic acid allyl ester

6.22 g (11.2 mmol) of the compound that is produced according to Example L1d is mixed with 2.54 ml of diethylamine and heated for 3 hours to 50° C. It is concentrated by evaporation, and the residue is purified by chromatography on fine silica gel. 3.26 g (9.7 mmol, 87%) of the title compound is isolated.

### Example L1

### (2S,5 S)-[5-{2-[11-(2,5-Dioxo-2,5-dihydro-pyrrol-1-yl)-undecanoylamino]-3-phenyl-propionylamino}-5-(4-hydroxymethyl-phenylcarbamoyl)-pentyl]-carbamic acid allyl ester

The solution of 2.58 g (7.7 mmol) of the compound, produced according to Example L1e, in 130 ml of dimethylformamide is mixed with 3.3 g of the compound that is produced according to Example L1b, 3.46 ml of 2,4,6-trimethylpyridine, 2.81 g of (O-(7-azabenzotriazol-1-yl)-N,N,N′,N′-tetramethyluroniumhexafluorophosphate), and it is stirred for 16 hours at 23° C. It is poured into 2N hydrochloric acid, extracted several times with ethyl acetate, the combined organic extracts are washed with water and dried on sodium sulfate. The residue that is obtained after filtration and removal of the solvent is purified by chromatography on fine silica gel. Subsequent recrystallization from ethyl acetate yields 2.04 g (2.73 mmol, 36%) of the title compound as a colorless solid.

¹H-NMR (d6-DMSO):═0.94-1.83 (22H), 2.02 (2H), 2.74 (1H), 2.91-3.11 (3H, 3.38 (2H), 4.31-4.51 (5H), 4.57 (1H), 5.10 (1H), 5.14 (1H), 5.24 (1H), 5.88 (1H), 7.00 (2H), 7.09-7.32 (8H), 7.55 (2H), 8.00 (1H), 8.12 (1H), 9.94 (1H) ppm.

### EXAMPLES OF SYNTHESIS OF EFFECTOR-LINKER UNITS (EL)

### Example EL1

### Carboxylic acid 4-(6-allyloxycarbonylamino-2(S)-{2(S)-[11-(2,5-dioxo-2,5-dihydro-pyrrol-1-yl)-undecanoylamino]-3-phenyl-propionylamino}-hexanoylamino)-benzyl ester (4S,7R,8S,9S,13Z,16S)-[7-allyl-8-hydroxy-5,5,9,13-tetramethyl-16-(2-methyl-benzothiazol-5-yl)-2,6-dioxo-oxacyclohexadec-13-en-4-yl]-ester

### Example EL1a

### Carboxylic acid 4-(6-allyloxycarbonylamino-2(S)-{2(S)-[11-(2,5-dioxo-2,5-dihydro-pyrrol-1-yl)-undecanoylamino]-3-phenyl-propionylamino}-hexanoylamino)-benzyl ester 4-(4S,7R,8S,9S,13Z,16S)-[7-allyl-8-(tert-butyl-dimethyl-silanyloxy)-5,5,9,13-tetramethyl-16-(2-methyl-benzothiazol-5-yl)-2,6-dioxo-oxacyclohexadec-13-en-4-yl]-ester

The solution of 375 mg (532 μmol) of (4S,7R,8S,9S,13Z,16S)-chloroformic acid-7-allyl-8-(tert-butyl-dimethyl-silanyloxy)-5,5,9,13-tetramethyl-16-(2-methyl-benzothiazol-5-yl)-2,6-dioxo-oxacyclohexadec-13-en-4-yl ester, which was produced analogously to the process described under DE 10234975.4 and DE 10305098.1, in 11.4 ml of dimethylformamide, is mixed with the solution of 2.07 g of the compound, produced according to Example L1, in 4.3 ml of dichloromethane, 274 mg of copper(I)chloride is added, and it is stirred for 5 hours at 23° C. It is poured into water, mixed with ethyl acetate, undissolved solid is filtered out, and it is extracted several times with ethyl acetate. The combined organic extracts are washed with saturated sodium chloride solution and dried on sodium sulfate. The residue that is obtained after filtration and removal of the solvent is purified by chromatography on fine silica gel. 66 mg (46.7 μmol, 9%) of the title compound is isolated.

### Example EL1

### Carboxylic acid 4-(6-allyloxycarbonylamino-2(S)-{2(S)-[11-(2,5-dioxo-2,5-dihydro-pyrrol-1-yl)-undecanoylamino]-3-phenyl-propionylamino}-hexanoylamino)-benzyl ester (4S,7R,8S,9S,13Z,16S)-[7-allyl-8-hydroxy-5,5,9,13-tetramethyl-16-(2-methyl-benzothiazol-5-yl)-2,6-dioxo-oxacyclohexadec-13-en-4-yl]-ester

The solution of 66 mg (46.7 μmol) of the compound that is produced according to Example EL1a in a mixture that consists of 0.77 ml of tetrahydrofuran and 0.77 ml of acetonitrile is mixed with 403 μl of hexafluorosilicic acid and 403 μl of hydrogen fluoride-pyridine complex. It is stirred for 23 hours at 23° C., mixed with water and extracted several times with ethyl acetate. The combined organic extracts are washed with saturated sodium bicarbonate solution and saturated sodium chloride solution and dried on sodium sulfate. The residue that is obtained after filtration and removal of the solvent is purified by chromatography on fine silica gel. 32 mg (24.6 μmol, 53%) of the title compound is isolated.

¹H-NMR (CDCl₃): δ=0.99 (3H), 1.11 (3H), 1.14 (3H), 1.17-1.89 (26), 1.70 (3H), 1.96 (2H), 2.18 (2H), 2.25-2.55 (5H), 2.67 (1H), 2.77 (3H), 2.93-3.26 (5H), 3.39 (1H), 3.50 (2H), 3.68 (1H), 4.38-4.78 (6H), 4.96-5.09 (3H), 5.13-5.23 (2H), 5.29 (1H), 5.55 (1H), 5.70 (1H), 5.90 (1H), 5.98 (1H), 6.09 (1H), 6.65 (1H), 6.68 (2H), 7.04 (2H), 7.11-7.34 (6H), 7.37 (1H), 7.47 (2H), 7.77 (1H), 7.96 (1H), 8.43 (1H) ppm.

### Example EL2

### Carboxylic acid 4-(6-allyloxycarbonylamino-2(S)-{2(S)-[11-(2,5-dioxo-2,5-dihydro-pyrrol-1-yl)-undecanoylamino]-3-phenyl-propionylamino}-hexanoylamino)-benzyl ester (1S,3S,7S,10R,l S,12S,16R)-[10-allyl-11-hydroxy-8,8,12,16-tetramethyl-3-(2-methyl-benzothiazol-5-yl)-5,9-dioxo-4,17-dioxa-bicyclo[14.1.0]heptadec-7-yl]-ester

The solution of 27 mg (20.8 μmol) of the compound, produced according to Example EL1, in 1.2 ml of dichloromethane is mixed at −40° C. under an atmosphere of dry argon with 0.5 ml of a 0.1M solution of dimethyl dioxiram in acetone, and it is stirred for 3 hours at −40° C. to −20° C. It is poured into a saturated sodium thiosulfate solution, diluted with water, and extracted several times with dichloromethane. The combined orgnaic extracts are washed with water and dried on sodium sulfate. The residue that is obtained after filtration and removal of the solvent is purified by chromatography on a silica gel plate. 13.3 mg (10.1 μmol, 49%) of the title compound as well as 7.6 mg (5.8 μmol, 28%) of carboxylic acid 4-(6-allyloxycarbonylamino-2(S)-{2(S)-[11-(2,5-dioxo-2,5-dihydro-pyrrol-1-yl)-undecanoylamino]-3-phenyl-propionylamino}-hexanoylamino)-benzyl ester (1R,3S,7S,10R,11S,12S,16S)-[10-allyl-11-hydroxy-8,8,12,16-tetramethyl-3-(2-methyl-benzothiazol-5-yl)-5,9-dioxo-4,17-dioxa-bicyclo[14.1.0]heptadec-7-yl]-ester are isolated.

¹H-NMR (CDCl₃): δ=1.00 (3H), 1.07-1.84 (33H), 1.48 (3H), 1.93 (1H), 2.13-2.57 (8H), 2.70 (1H), 2.79 (3H), 2.85 (1H), 3.02 (1H), 3.08-3.21 (3H), 3.45 (1H), 3.50 (2H), 3.69 (1H), 4.40-4.62 (4H), 4.67-4.76 (2H), 4.99 (1H), 5.04 (1H), 5.13 (1H), 5.19 (1H), 5.28 (1H), 5.44 (1H), 5.69 (1H), 5.90 (1H), 6.07 (1H), 6.27 (1H), 6.68 (2H), 6.87 (1H), 7.07 (2H), 7.10-7.21 (5H), 7.31 (1H), 7.47 (2H), 7.78 (1H), 7.93 (1H), 8.50 (1H), 9.67 (1H) ppm.

### Example EL3

### Carboxylic acid 4-(6-amino-2(S)-{2(S)-[11-(2,5-dioxo-2,5-dihydro-pyrrol-1-yl)-undecanoylamino]-3-phenyl-propionylamino}-hexanoylamino)-benzyl ester (1S,3S,7S,10R,11S,12S,16R)-[10-allyl-11-hydroxy-8,8,12,16-tetramethyl-3-(2-methyl-benzothiazol-5-yl)-5,9-dioxo-4,17-dioxa-bicyclo[14.1.0]heptadec-7-yl]-ester

The solution of 13 mg (10.1 μmol) of the compound, produced according to Example EL2, in 0.5 ml of dichloromethane is mixed with 2.53 μl of phenylsilane, the solution of 772 μg of tetrakis-triphenylphosphonium palladium (0) in 1.0 ml of dichloromethane, and it is stirred for 2.5 hours at 23° C. It is concentrated by evaporation, and the residue is purified by chromatography on a silica gel plate. 4.2 mg (3.4 μmol, 34%) of the title compound is isolated.

MS: m/z=1231

### EXAMPLES OF THE SYNTHESIS OF EFFECTOR-LINKER-RECOGNITION UNIT CONJUGATES (ELE)

### Example ELE1

### Carboxylic acid 4-(6-amino-2(S)-{2(S)-[11-(3-(AP39r)-sulfanyl-2,5-dioxo-pyrrolidin-1-yl)-undecanoylamino]-3-phenyl-propionylamino}-hexanoylamino)-benzyl ester (1S,3S,7S,10R,11S,12S,16R)-[10-allyl-11-hydroxy-8,8,12,16-tetramethyl-3-(2-methyl-benzothiazol-5-yl)-5,9-dioxo-4,17-dioxa-bicyclo[14.1.0]heptadec-7-yl]-ester

50 μl of a 1.5 mmol solution of the effector-linker conjugate, produced according to Example EL3, in DMSO is added to 400 μl of a solution of the reduced antibody fragment AP39r with a content of 0.7 mg/ml, which was produced analogously to the process that is described under DE 10234975.4 and DE 10305098.1, mixed with 170 μl of PBS and incubated at 25° C. for 1 hour. It is desalinated with a pre-equilibrated NAP5 column at a concentration with 400 μl of the reaction solution. After elution with PBS, the solution of the title compound is isolated. The dilution factor relative to the antibody fragment is about 1.8.

m/z=26710±20

Without further elaboration, it is believed that one skilled in the art can, using the preceding description, utilize the present invention to its fullest extent. The following preferred specific embodiments are, therefore, to be construed as merely illustrative, and not limitative of the remainder of the disclosure in any way whatsoever.

In the foregoing and in the following examples, all temperatures are set forth uncorrected in degrees Celsius and, all parts and percentages are by weight, unless otherwise indicated.

The entire disclosures of all applications, patents and publications, cited herein and of corresponding German application No. 102004004787.1, filed Jan. 20, 2004 and U.S. Provisional Application Ser. No. 60/539,977, filed Jan. 30, 2004, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Effector conjugate of general formula (I): 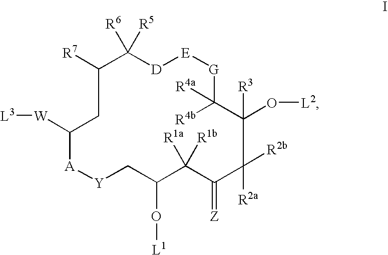
in which
R^{1a}, R^{1b}, independently of one another, are hydrogen, C₁-C₁₀ alkyl, aryl, aralkyl, or together a —(CH₂)ₘgroup, in which m is 2 to 5,
R^{2a}, R^{2b}, independently of one another, are hydrogen, C₁-C₁₀ alkyl, aryl, aralkyl, or together a —(CH₂)n group, in which n is 2 to 5, or C₂-C₁₀ alkenyl, or C₂-C₁₀ alkinyl,
R³ is hydrogen, C₁-C₁₀ alkyl, aryl or aralkyl, and
R^{4a}, R^{4b}, independently of one another, are hydrogen, C₁-C₁₀ alkyl, aryl, aralkyl, or together a —(CH₂)ₚ group, in which p is 2 to 5,
R⁵ is hydrogen, C₁-C₁₀ alkyl, aryl, aralkyl, CO₂H, CO₂alkyl, CH₂OH, CH₂Oalkyl, CH₂Oacyl, CN, CH₂NH₂, CH₂N(alkyl, acyl)_{1,2}, or CH₂Hal,
Hal is a halogen atom,
R⁶, R⁷, in each case, are hydrogen, or together an additional bond or together an oxygen atom, or together an NH group, or together an N-alkyl group, or together a CH₂ group, and
G is an oxygen atom or CH₂,
D-E is a group H₂C—CH₂, HC═CH, C≡C, CH(OH)—CH(OH), CH(OH)—CH₂, CH₂—CH(OH), 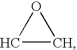
O—CH₂, or, if G represents a CH₂ group, D-E is also CH₂—O,
W is a group C(═X)R⁸, or a bi- or tricyclic aromatic or heteroaromatic radical,
L³ is hydrogen, or, if a radical in W contains a hydroxyl group, forms a group O-L⁴ with the latter, or, if a radical in W contains an amino group, forms a group NR²⁵-L⁴ with the latter,
R²⁵ is hydrogen or C₁-C₁₀ alkyl,
X is an oxygen atom, or two OR²⁰ groups, or a C₂-C₁₀ alkylenedioxy group, which should be straight-chain or branched, or H/OR⁹, or a CR¹⁰R¹¹ group,
R⁸ is hydrogen, C₁-C₁₀ alkyl, aryl, aralkyl, halogen or CN, and
R⁹ is hydrogen or a protective group PG^{X},
R¹⁰, R¹¹, in each case independently of one another, are hydrogen, C₁-C₂₀ alkyl, aryl, or aralkyl, or together with a methylene carbon atom form a 5- to 7-membered carbocyclic ring,
Z can represent oxygen or H/OR¹²,
R¹² can represent hydrogen or a protective group PG^{Z},
A-Y can represent a group O—C(═O), O—CH₂, CH₂—C(═O), NR²¹—C(═O) or NR²¹—SO₂,
R²⁰ can represent C₁-C₂₀ alkyl,
R²¹ can represent a hydrogen atom or C₁-C₁₀ alkyl,
PG^{X}, PG^{Y}, and PG^{Z} can represent a protective group PG, and
L¹, L², L⁴, independently of one another, can represent hydrogen, a group C(═O)Cl, a group C(═S)Cl, a group PG^{Y} or a linker of general formula (III); with the condition that at least one substituent L¹, L² or L⁴ represents a linker of general formula (III);
the linker of general formula (III) has the following structure, 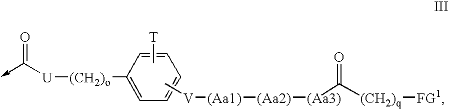
in which
T represents halogen, OH, O-alkyl, CO₂H, CO₂-alkyl, —NHR²³, —NO₂, —N₃, —CN, C₁-C₂₀-alkyl, C₁-C₂₀-acyl or C₁-C₂₀-acyloxy groups,
U represents a bond, oxygen, or NR^{24a},
o represents 0 to 5,
V represents oxygen or NR^{24b},
Aa1 represents a bond or a group of general formula IV and
Aa2, Aa3, independently of one another, represent a group of general formula IV 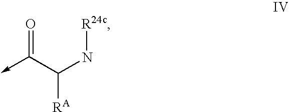
which is derived from a natural or unnatural amino acid HO-Aa1-H, HO-Aa2-H, or HO-Aa3-H of general formula IV′ 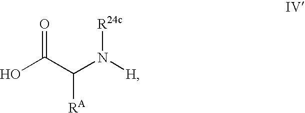
in which R^{A} can be the same or different in HO-Aa1-H, HO-Aa2-H, or HO-Aa3-H, and the a-substituent represents a natural or unnatural amino acid,
R²² can represent hydrogen, C₁-C₁₀ alkyl, aryl or aralkyl,
R²³ can represent hydrogen, C₁-C₁₀ alkyl, or C₁-C₁₀ acyl,
R^{24a}, R^{24b}, R^{24c}, independently of one another, can represent hydrogen or C₁-C₁₀ alkyl,
q can represent 1 to 20,
FG¹ can represent C₁-C₁₀ alkyl-S₃, 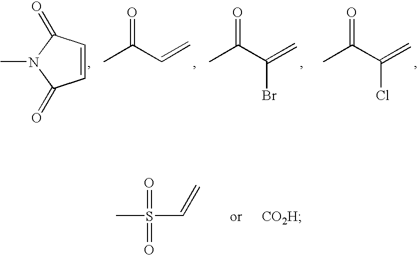
as a uniform isomer or a mixture of different isomers and/or as a pharmaceutically acceptable salt thereof.

2. Effector conjugate according to claim 1, whereby:
A-Y represents O—C(═O) or NR²¹—C(═O);
D-E represents an H₂C—CH₂ group or an HC═CH group;
G represents a CH₂ group;
z represents an oxygen atom;
R^{1a}, R^{1b} in each case represent C₁-C₁₀ alkyl or together a —CH₂)ₚ group with p equal to 2 or 3 or 4;
R^{2a}, R^{2b}, independently of one another, represent hydrogen, C₁-C₁₀ alkyl, C₂-C₁₀ alkenyl, or C₂-C₁₀ alkinyl;
R³ represents hydrogen;
R^{4a}, R^{4b}, independently of one another, represent hydrogen or C₁-C₁₀ alkyl;
R⁵ represents hydrogen or C₁-C₄ alkyl or CH₂OH or CH₂NH₂ or CH₂N(alkyl, acyl)_{1,2} or CH₂Hal;
R⁶ and R⁷ together represent an additional bond or together an NH group or together an N-alkyl group or together a CH₂ group or together an oxygen group;
W represents a group C(═X)R⁸ or a 2-methylbenzothiazol-5-yl radical or a 2-methylbenzoxazol-5-yl radical or a quinolin-7-yl radical or a 2-aminomethylbenzothiazol-5-yl radical or a 2-hydroxymethylbenzothiazol-5-yl radical or a 2-aminomethylbenzoxazol-5-yl radical or a 2-hydroxymethyl-benzoxazol-5-yl radical;
X represents a CR¹⁰R¹¹ group;
R⁸ represents hydrogen or C₁-C₄ alkyl or a fluorine atom or a chlorine atom or a bromine atom;
R¹⁰/R¹¹ represent hydrogen/2-methylthiazol-4-yl or hydrogen/2-pyridyl or hydrogen/2-methyloxazol-4-yl or hydrogen/2-aminomethylthiazol-4-yl or hydrogen/2-aminomethyloxazol-4-yl or hydrogen/2-hydroxymethylthiazol-4-yl or hydrogen/2-hydroxymethyloxazol-4-yl.

3. Effector conjugate according to claim 1, whereby the effector element is selected from the group that consists of:
(4S,7R,8S,9S,13Z,16S(E))-4,8-Dihydroxy-5,5,7,9, 13-pentamethyl-16-[1-methyl-2-(2-methyl-thiazol-4-yl)-vinyl]-oxacyclohexadec-13-ene-2,6-dione;
(4S,7R,8S,9S,13Z,16S(E))-4,8-Dihydroxy-16-[2-(2-hydroxymethyl-thiazol-4-yl)-1-methyl-vinyl]-5,5,7,9,13-pentamethyl-oxacyclohexadec-13-ene-2,6-dione;
(4S,7R,8S,9S,13Z,16S(E))-16-[2-(2-Aminomethyl-thiazol-4-yl)-1-methyl-vinyl]-4,8-dihydroxy-5,5,7,9,13-pentamethyl-oxacyclohexadec-13-ene-2,6-dione;
(1S,3S(E),7S,10R,11S,12S,16R)-7,11-Dihydroxy-8,8,10,12,16-pentamethyl-3-[1-methyl-2-(2-methyl-thiazol-4-yl)-vinyl]-4,17-dioxa-bicyclo[14.1.0]heptadecane-5,9-dione;
(1S,3S(E),7S,10R,11S,12S,16R)-7,11-Dihydroxy-3-[2-(2-hydroxymethyl=thiazol-4-yl)-1-methyl-vinyl]-8,8,10,12,16-pentamethyl-4,17-dioxa-bicyclo[14.1.0]-heptadecane-5,9-dione;
(1S,3S(E),7S,10R,11S,12S,16R)-3-[2-(2-Aminomethyl-thiazol-4-yl)-1-methyl-vinyl]-7,11-dihydroxy-8,8,10,12,16-pentamethyl-4,17-dioxa-bicyclo[14.1.0]-heptadecane-5,9-dione;
(4S,7R,8S,9S,13Z,16S(E))-4,8-Dihydroxy-7-ethyl-5,5,9,13-tetramethyl-16-[1-methyl-2-(2-methyl-thiazol-4-yl)-vinyl]-oxacyclohexadec-13-ene-2,6-dione;
(4S,7R,8S,9S,13Z,16S(E))-4,8-Dihydroxy-16-[2-(2-hydroxymethyl-thiazol-4-yl)-1-methyl-vinyl]-7-ethyl-5,5,9,13-tetramethyl-oxacyclohexadec-13-ene-2,6-dione;
(4S,7R,8S,9S,13Z,16S(E))-16-[2-(2-Aminomethyl-thiazol-4-yl)-1-methyl-vinyl]4,8-dihydroxy-7-ethyl-5,5,9,13-tetramethyl-oxacyclohexadec-13-ene-2,6-dione;
(1S,3S(E),7S,10R,11S,12S,16R)-7,11-Dihydroxy-10-ethyl-8,8,12,16-tetramethyl-3-]1-methyl-2-(2-methyl-thiazol-4-yl)-vinyl]-4,17-dioxa-bicyclo[14.1.0]-heptadecane-5,9-dione;
(1S,3S(E),7S,10R,11S,12S,16R)-7,11-Dihydroxy-3-[2-(2-hydroxymethyl-thiazol-4-yl)-1-methyl-vinyl]-10-ethyl-8,8,12,16-tetramethyl-4,17-dioxa-bicyclo[14.1.0]heptadecane-5,9-dione;
(1S,3S(E),7S,10R,11S,12S,16R)-3-[2-(2-Aminomethyl-thiazol-4-yl)-1-methyl-vinyl]-7,11-dihydroxy-10-ethyl-8,8,12,16-tetramethyl-4,17-dioxa-bicyclo[14.1.0]-heptadecane-5,9-dione;
(4S,7R,8S,9S,13Z,16S(Z))-4,8-Dihydroxy-5,5,7,9,13-pentamethyl-16-[1-fluoro-2-(2-methyl-thiazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-thiazol-4-yl)-1-fluoro-vinyl]-5,5,7,9,13-pentamethyl-oxacyclohexadec-13-ene-2,6-dione;
(4S,7R,8S,9S,13Z,16S(Z))-16-[2-(2-Aminomethyl-thiazol-4-yl)-1-fluoro-vinyl]-4,8-dihydroxy-5,5,7,9,13-pentamethyl-oxacyclohexadec-13-ene-2,6-dione;
(1S,3S(Z),7S,10R,11S,12S,16R)-7,11-Dihydroxy-8,8,10,12,16-pentamethyl-3-]1-fluoro-2-(2-methyl-thiazol-4-yl)-vinyl]-4,17-dioxa-bicyclo[14.1.0]heptadecane-5,9-dione;
(1S,3S(Z),7S,10R,11S,12S,16R)-7,11-Dihydroxy-3-[2-(2-hydroxymethyl-thiazol-4-yl)-1- fluoro-vinyl]-8,8,10,12,16-pentamethyl-4,17-dioxa-bicyclo[14.1.0]-heptadecane-5,9-dione;
(1S,3S(Z),7S,10R,11S,12S,16R)-3-[2-(2-Aminomethyl-thiazol-4-yl)-1-fluoro-vinyl]- 7,11-dihydroxy-8,8,10,12,16-pentamethyl-4,17-dioxa-bicyclo[14.1.0]-heptadecane-5,9-dione;
(4S,7R,8S,9S,13Z,16S(Z))-4,8-Dihydroxy-5,5,7,9,13-pentamethyl-16-[1-chloro-2-(2-methyl-thiazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-thiazol-4-yl)-1-chloro-vinyl]-5,5,7,9,13-pentamethyl-oxacyclohexadec-13-ene-2,6-dione;
(4S,7R,8S,9S,13Z,16S(Z))-16-[2-(2-Aminomethyl-thiazol-4-yl)-1-chloro-vinyl]-4,8-dihydroxy-5,5,7,9,13-pentamethyl-oxacyclohexadec-13-ene-2,6-dione;
(1S,3S(Z),7S,10R,11S,12S,16R)-7,11-Dihydroxy-8,8,10,12,16-pentamethyl-3-[1-chloro-2-(2-methyl-thiazol-4-yl)-vinyl]-4,17-dioxa-bicyclo[14.1.0]heptadecane-5,9-dione;
(1S,3S(Z),7S,10R,11S,12S,16R)-7,11-Dihydroxy-3-[2-(2-hydroxymethyl-thiazol-4-yl)-1-chloro-vinyl]-8,8,10,12,16-pentamethyl-4,17-dioxa-bicyclo[14.1.0]-heptadecane-5,9-dione;
(1S,3S(Z),7S,10R,11S,12S,16R)-3-[2-(2-Aminomethyl-thiazol-4-yl)-1-chloro-vinyl]-7,11-dihydroxy-8,8,10,12,16-pentamethyl-4,17-dioxa-bicyclo[14.1.0]-heptadecane-5,9-dione;
(4S,7R,8S,9S,13Z,16S(Z))-4,8-Dihydroxy-7-ethyl-5,5,9,13-tetramethyl-16-[1-fluoro-2-92-methyl-thiazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-thiazol-4-yl)-1-fluoro-vinyl]-7-ethyl-5,5,9,13-tetramethyl-oxacyclohexadec-13-ene-2,6-dione;
(4S,7R,8S,9S,13Z,16S(Z))-16-[2-(2-Aminomethyl-thiazol-4-yl)-1-fluoro-vinyl]-4,8-dihydroxy-7-ethyl-5,5,9,13-tetramethyl-oxacyclohexadec-13-ene-2,6-dione;
(1S,3S(Z),7S,10R,11S,12S,16R)-7,11-Dihydroxy-10-ethyl-8,8,12,16-tetramethyl-3-]1-fluoro-2-(2-methyl-thiazol-4-yl)-vinyl]-4,17-dioxa-bicyclo[14.1.0]-heptadecane-5,9-dione;
(1S,3S(Z),7S,10R,11S,12S,16R)-7,11-Dihydroxy-3-[2-(2-hydroxymethyl-thiazol-4-yl)-1-fluoro-vinyl]-10-ethyl-8,8,12,16-tetramethyl-4,17-dioxa-bicyclo[14.1.0]-heptadecane-5,9-dione;
(1S,3S(Z),7S,10R,11S,12S,16R)-3-[2-(2-Aminomethyl-thiazol-4-yl)-1-fluoro-vinyl]-7,11-dihydroxy-10-ethyl-8,8,12,16-tetramethyl-4,17-dioxa-bicyclo[14.1.0]-heptadecane-5,9-dione;
(4S,7R,8S,9S,13Z,16S(Z))-4,8-Dihydroxy-7-ethyl-5,5,9,13-tetramethyl-16-[1chloro-2-(2-methyl-thiazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-thiazol-4-yl)-1-chloro-vinyl]-7-ethyl-5,5,9,13-tetramethyl-oxacyclohexadec-13-ene-2,6-dione;
(4S,7R,8S,9S,13Z,16S(Z))-16-[2-(2-Aminomethyl-thiazol-4-yl)-1-chloro-vinyl]-4,8-dihydroxy-7-ethyl-5,5,9,13-tetramethyl-oxacyclohexadec-13-ene-2,6-dione;
(1S,3S(Z),7S,10R,11S,12S,16R)-7,11-Dihydroxy-10-ethyl-8,8,12,16-tetramethyl-3-]1-chloro-2-(2-methyl-thiazol-4-yl)-vinyl]-4,17-dioxa-bicyclo[14.1.0]-heptadecane-5,9-dione;
(1S,3S(Z),7S,10R,11S,12S,16R)-7,11-Dihydroxy-3-[2-(2-hydroxymethyl-thiazol-4-yl)-1-chloro-vinyl]-10-ethyl-8,8,12,16-tetramethyl-4,17-dioxa-bicyclo[14.1.0]-heptadecane-5,9-dione;
(1S,3S(Z),7S,10R,11S,12S,16R)-3-[2-(2-Aminomethyl-thiazol-4-yl)-1-chloro-vinyl]-7,11-dihydroxy-10-ethyl-8,8,12,16-tetramethyl-4,17-dioxa-bicyclo[14.1.0]-heptadecane-5,9-dione;
(4S,7R,8S,9S,13Z,16S(E))-4,8-Dihydroxy-5,5,7,9,13-pentamethyl-16-[1-methyl-2-(2-pyridyl)-vinyl]-oxacyclohexadec-13-ene-2,6-dione;
(1S,3S(E),7S,10R,11S,12S,16R)-7,11-Dihydroxy-8,8,10,12,16-pentamethyl-3-[1-methyl-2-(2-pyridyl)-vinyl]-4,17-dioxa-bicyclo[14.1.0]heptadecane-5,9-dione;
(4S,7R,8S,9S,13Z,16S(E))-4,8-Dihydroxy-7-ethyl-5,5,9,13-tetramethyl-16-[1-methyl-2-(2-pyridyl)-vinyl]-oxacyclohexadec-13-ene-2,6-dione;
(1S,3S(E),7S,10R,11S,12S,16R)-7,11-Dihydroxy-10-ethyl-8,8,12,16-tetramethyl-3-[1-methyl-2-(2-pyridyl)-vinyl]-4,17-dioxa-bicyclo[14.1.0]heptadecane-5,9-dione;
(4S,7R,8S,9S,13Z,16S(Z))-4,8-Dihydroxy-5,5,7,9,13-pentamethyl-16-[1-fluoro-2(2-pyridyl)-vinyl]-oxacyclohexadec-13-ene-2,6-dione;
(1S,3S(Z),7S,10R,11S,12S,16R)-7,11-Dihydroxy-8,8,10,12,16-pentamethyl-3-[1-fluoro-2-(2-pyridyl)-vinyl]-4,17-dioxa-bicyclo[14.1.0]heptadecane-5,9-dione;
(4S,7R,8S,9S,13Z,16S(Z))-4,8-Dihydroxy-5,5,7,9,13-pentamethyl-16-[1-chloro-2(2-pyridyl)-vinyl]-oxacyclohexadec-13-ene-2,6-dione;
(1S,3S(Z),7S,10R,11S,12S,16R)-7,11-Dihydroxy-8,8,10,12,16-pentamethyl-3-]1-chloro-2-(2-pyridyl)-vinyl]-4,17-dioxa-bicyclo[14.1.0heptadecane-5,9-dione;
(4S,7R,8S,9S,13Z,16S(Z))-4,8-Dihydroxy-7-ethyl-5,5,9,13-tetramethyl-16-[1-fluoro-2-(2-pyridyl)-vinyl]-oxacyclohexadec-13-ene-2,6-dione;
(1S,3S(Z),7S,10R,11S,12S,16R)-7,11-Dihydroxy-10-ethyl-8,8,12,16-tetramethyl-3-[1-fluoro-2-(2-pyridyl)-vinyl]-4,17-dioxa-bicyclo[14.1.0]heptadecane-5,9-dione;
(4S,7R,8S,9S,13Z,16S(Z))-4,8-Dihydroxy-7-ethyl-5,5,9,13-tetramethyl-16-[1-chloro-2(2-(2-pyridyl)-vinyl]-oxacyclohexadec-13-ene-2,6-dione;
(1S,3S(Z),7S,10R,11S,12S,16R)-7,11-Dihydroxy-10-ethyl-8,8,12,16-tetramethyl-3-[1-chloro-2-(2-pyridyl)-vinyl]-4,17-dioxa-bicyclo[14.1.0]heptadecane-5,9-dione;
(4S,7R,8S,9S,13Z,16S(E))-4,8-Dihydroxy-5,5,7,9,13-pentamethyl-16-[1-methyl-2-(2-methyl-oxazol-4-yl)-vinyl]-oxacyclohexadec-13-ene-2,6-dione;
(4S,7R,8S,9S,13Z,16S(E))-4,8-Dihydroxy-16-[2-(2-hydroxymethyl-oxazol-4-yl)-1-methyl-vinyl]-5,5,7,9,13-pentamethyl-oxacyclohexadec-13-ene-2,6-dione;
(4S,7R,8S,9S,13Z,16S(E))-16-[2-(2-Aminomethyl-oxazol-4-yl)-1-methyl-vinyl]-4,8-dihydroxy-5,5,7,9,13-pentamethyl-oxacyclohexadec-13-ene-2,6-dione;
(1S,3S(E),7S,10R,11S,12S,16R)-7,11-Dihydroxy-8,8,10,12,16-pentamethyl-3-[1-methyl-2-(2-methyl-oxazol-4-yl)-vinyl]-4,17-dioxa-bicyclo[14.1.0]heptadecane-5,9-dione;
(1S,3S(E),7S,10R,11S,12S,16R)-7,11-Dihydroxy-3-[2-(2-hydroxymethyl-oxazol-4-yl)-1-methyl-vinyl]-8,8,10,12,16-pentamethyl-4,17-dioxa-bicyclo[14.1.0]-heptadecane-5,9-dione;
(1S,3S(E),7S,10R,11S,12S,16R)-3-[2-(2-Aminomethyl-oxazol-4-yl)-1-methyl-vinyl]-7,11-dihydroxy-8,8,10,12,16-pentamethyl-4,17-dioxa-bicyclo[14.1.0]-heptadecane-5,9-dione;
(4S,7R,8S,9S,13Z,16S(E))-4,8-Dihydroxy-7-ethyl-5,5,9,13-tetramethyl-16-[1-methyl-2-(2-methyl-oxazol-4-yl)-vinyl]-oxacyclohexadec-13-ene-2,6-dione;
(4S,7R,8S,9S,13Z,16S(E))-4,8-Dihydroxy-16-[2-(2-hydroxymethyl-oxazol-4-yl)-1-methyl-vinyl]-7-ethyl-5,5,9,13-tetramethyl-oxacyclohexadec-13-ene-2,6-dione;
(4S,7R,8S,9S,13Z,16S(E))-16-[2-(2-Aminomethyl-oxazol-4-yl)-1-methyl-vinyl]-4,8-dihydroxy-7-ethyl-5,5,9,13-tetramethyl-oxacyclohexadec-13-ene-2,6-dione;
(1S,3S(E),7S,10R,11S,12S,16R)-7,11-Dihydroxy-10-ethyl-8,8,12,16-tetramethyl-3-[1-methyl-2-(2-methyl-oxazol-4-yl)-vinyl]-4,17-dioxa-bicyclo[14.1.0]-heptadecane-5,9-dione;
(1S,3S(E),7S,10R,11S,12S,16R)-7,11-Dihydroxy-3-[2-(2-hydroxymethyl-oxazol-4-yl)-1-methyl-vinyl]-10-ethyl-8,8,12,16-tetramethyl-4,17-dioxa-bicyclo[14.1.0]heptadecane-5,9-dione;
(1S,3S(E),7S,10R,11S,12S,16R)-3-[2-(2-Aminomethyl-oxazol-4-yl)-1-methyl-vinyl]-7,11-dihydroxy-10-ethyl-8,8,12,16-tetramethyl-4,17-dioxa-bicyclo[14.1.0]-heptadecane-5,9-dione;
(4S,7R,8S,9S,13Z,16S(Z))-4,8-Dihydroxy-5,5,7,9,13-pentamethyl-16-[1-fluoro-2-(2-methyl-oxazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-oxazol-4-yl)-1-fluoro-vinyl]-5,5,7,9,13-pentamethyl-oxacyclohexadec-13-ene-2,6-dione;
(4S,7R,8S ,9S,13Z,16S(Z))-16-[2-(2-Aminomethyl-oxazol-4-yl)-1-fluoro-vinyl]-4,8-dihydroxy-5,5,7,9,13-pentamethyl-oxacyclohexadec-13-ene-2,6-dione;
(1S,3S(Z),7S,10R,11S,12S,16R)-7,11-Dihydroxy-8,8,10,12,16-pentamethyl-3-[1-fluoro-2-(2-methyl-oxazol-4-yl)-vinyl]-4,17-dioxa-bicyclo[14.1.0]heptadecane-5,9-dione;
(1S,3S(Z),7S,10R,11S,12S,16R)-7,11-Dihydroxy-3-[2-(2-hydroxymethyl-oxazol-4-yl)-1-fluoro-vinyl]-8,8,10,12,16-pentamethyl-4,17-dioxa-bicyclo[14.1.0]-heptadecane-5,9-dione;
(1S,3S(Z),7S,10R,11S,12S,16R)-3-[2-(2-Aminomethyl-oxazol-4-yl)-1-fluoro-vinyl]-7,11-dihydroxy-8,8,10,12,16-pentamethyl-4,17-dioxa-bicyclo[14.1.0]-heptadecane-5,9-dione;
(4S,7R,8S,9S,13Z,16S(Z))-4,8-Dihydroxy-5,5,7,9,13-pentamethyl-16-[1-chloro-2-(2-methyl-oxazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-oxazol-4-yl)-1-chloro-vinyl]-5,5,7,9,13-pentamethyl-oxacyclohexadec-13-ene-2,6-dione;
(4S,7R,8S,9S,13Z,16S(Z))-16-[2-(2-Aminomethyl-oxazol-4-yl)-1-chloro-vinyl]-4,8-dihydroxy-5,5,7,9,13-pentamethyl-oxacyclohexadec-13-ene-2,6-dione;
(1S,3S(Z),7S,10R,11S,12S,16R)-7,11-Dihydroxy-8,8,10,12,16-pentamethyl-3-[1-chloro-2-(2-methyl-oxazol-4-yl)-vinyl]-4,17-dioxa-bicyclo[14.1.0]heptadecane-5,9-dione;
(1S,3S(Z),7S,10R,11S,12S,16R)-7,11-Dihydroxy-3-[2-(2-hydroxymethyl-oxazol-4-yl)-1-chloro-vinyl]-8,8,10,12,16-pentamethyl-4,17-dioxa-bicyclo[14.1.0]-heptadecane-5,9-dione;
(1S,3S(Z),7S,10R,11S,12S,16R)-3-[2-(2-Aminomethyl-oxazol-4-yl)-1-chloro-vinyl]-7,11-dihydroxy-8,8,10,12,16-pentamethyl-4,17-dioxa-bicyclo[14.1.0]-heptadecane-5,9-dione;
(4S,7R,8S,9S,13Z,16S(Z))-4,8-Dihydroxy-7-ethyl-5,5,9,13-tetramethyl-16-[1-fluoro-2-(2-methyl-oxazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-oxazol-4-yl)-1-fluoro-vinyl]-7-ethyl-5,5,9,13-tetramethyl-oxacyclohexadec-13-ene-2,6-dione;
(4S,7R,8S,9S,13Z,16S(Z))-16-[2-(2-Aminomethyl-oxazol-4-yl)-1-fluoro-vinyl]-4,8-dihydroxy-7-ethyl-5,5,9,13-tetramethyl-oxacyclohexadec-13-ene-2,6-dione;
(1S,3S(Z),7S,10R,11S,12S,16R)-7,11-Dihydroxy-10-ethyl-8,8,12,16-tetramethyl-3-]1-fluoro-2-(2-methyl-oxazol-4-yl)-vinyl]-4,17-dioxa-bicyclo[14.1.0]-heptadecane-5,9-dione;
(1S,3S(Z),7S,10R,11S,12S,16R)-7,11-Dihydroxy-3-[2-(2-hydroxymethyl-oxazol-4-yl)-1-fluoro-vinyl]-10-ethyl-8,8,12,16-tetramethyl-4,17-dioxa-bicyclo[14.1.0]heptadecane-5,9-dione;
(1S,3S(Z),7S,10R,11S,12S,16R)-3-[2-(2-Aminomethyl-oxazol-4-yl)-1-fluoro-vinyl]-7,11-dihydroxy-10-ethyl-8,8,12,16-tetramethyl-4,17-dioxa-bicyclo[14.1.0]-heptadecane-5,9-dione;
(4S,7R,8S,9S,13Z,16S(Z))-4,8-Dihydroxy-7-ethyl-5,5,9,13-tetramethyl-16-[1-chloro-2-(2-methyl-oxazol-4-yl)-vinyl]-oxacyclohexadec-13-ene-2,6-dione;
(4S,7R,8S,9S,13Z,16S(Z))-4,8-Dihydroxy-16-[2-(2-hydroxymethyl-oxazol-4-yl)-1-chloro-vinyl]-7-ethyl-5,5,9,13-tetramethyl-oxacyclohexadec-13-ene-2,6-dione;
(4S,7R,8S,9S,13Z,16S(Z))-16-[2-(2-Aminomethyl-oxazol-4-yl)-1-chloro-vinyl]-4,8-dihydroxy-7-ethyl-5,5,9,13-tetramethyl-oxacyclohexadec-13-ene-2,6-dione;
(1S,3S(Z),7S,10R,11S,12S,16R)-7,1-Dihydroxy-10-ethyl-8,8,12,16-tetramethyl-3-[1-chloro-2-(2-methyl-oxazol-4-yl)-vinyl]-4,17-dioxa-bicyclo[14.1.0]-heptadecane-5,9-dione;
(1S,3S(Z),7S,10R,11S,12S,16R)-7,11-Dihydroxy-3-[2-(2-hydroxymethyl-oxazol-4-yl)-1-chloro-vinyl]-10-ethyl-8,8,12,16-tetramethyl-4,17-dioxa-bicyclo[14.1.0]heptadecane-5,9-dione;
(1S,3S(Z),7S,10R,11S,12S,16R)-3-[2-(2-Aminomethyl-oxazol-4-yl)-1-chloro-vinyl]-7,11-dihydroxy-10-ethyl-8,8,12,16-tetramethyl-4,17-dioxa-bicyclo[14.1.0]-heptadecane-5,9-dione;
(4S,7R,8S,9S,13Z,16S(E))-4,8-Dihydroxy-5,5,7,9,13-pentamethyl-16-[2-(2-methyl-thiazol-4-yl)-vinyl]-oxacyclohexadec-13-ene-2,6-dione;
(4S,7R,8S,9S,13Z,16S(E))-4,8-Dihydroxy-16-[2-(2-hydroxymethyl-thiazol-4yl)-vinyl]-5,5,7,9,13-pentamethyl-oxacyclohexadec-13-ene-2,6-dione;
(4S,7R,8S,9S,13Z,16S(E))-16-[2-(2-Aminomethyl-thiazol-4-yl)-vinyl]-4,8-dihydroxy-5,5,7,9,13-pentamethyl-oxacyclohexadec-13-ene-2,6-dione;
(1S,3S(E),7S,10R,11S,12S,16R)-7,11-Dihydroxy-8,8,10,12,16-pentamethyl-3-[2-(2-methyl-thiazol-4-yl)-vinyl]-4,17-dioxa-bicyclo[14.1.0]heptadecane-5,9-dione;
(1S,3S(E),7S,10R,11S,12S,16R)-7,11-Dihydroxy-3-[2-(2-hydroxymethyl-thiazol-4-yl)-vinyl]-8,8,10,12,16-pentamethyl-4,17-dioxa-bicyclo[14.1.0]heptadecane-5,9-dione;
(1S,3S(E),7S,10R,11S,12S,16R)-3-[2-(2-Aminomethyl-thiazol-4-yl)-vinyl]-7,11-dihydroxy-8,8,10,12,16-pentamethyl-4,17-dioxa-bicyclo[14.1.0]heptadecane-5,9-dione;
(4S,7R,8S,9S,13Z,16S(E))-4,8-Dihydroxy-7-ethyl-5,5,9,13-tetramethyl-16-[2-(2-methyl-thiazol-4-yl)-vinyl]-oxacyclohexadec-13-ene-2,6-dione;
(4S,7R,8S ,9S,13Z,16S(E))-4,8-Dihydroxy-16-[2-(2-hydroxymethyl-thiazol-4-yl)-vinyl]-7-ethyl-5,5,9,13-tetramethyl-oxacyclohexadec-13-ene-2,6-dione;
(4S,7R,8S,9S,13Z,16S(E))-16-[2-(2-Aminomethyl-thiazol-4-yl)-vinyl]-4,8-dihydroxy-7-ethyl-5,5,9,13-tetramethyl-oxacyclohexadec-13-ene-2,6-dione;
(1S,3S(E),7S,10R,11S,12S,16R)-7,11-Dihydroxy-10-ethyl-8,8,12,16-tetramethyl-3-]2-(2-methyl-thiazol-4-yl)-vinyl]-4,17-dioxa-bicyclo[14.1.0]heptadecane-5,9-dione;
(1S,3S(E),7S,10R,11S,12S,16R)-7,11-Dihydroxy-3-[2-(2-hydroxymethyl-thiazol-4-yl)-vinyl]-10-ethyl-8,8,12,16-tetramethyl-4,17-dioxa-bicyclo[14.1.0]-heptadecane-5,9-dione;
(1S,3S(E),7S,10R,11S,12S,16R)-3-[2-(2-Aminomethyl-thiazol-4-yl)-vinyl]-7,11-dihydroxy-10-ethyl-8,8,12,16-tetramethyl-4,17-dioxa-bicyclo[14.1.0]heptadecane-5,9-dione;
(4S,7R,8S,9S,13Z,16S(E))-4,8-Dihydroxy-5,5,7,9,13-pentamethyl-16-[2-(2-pyridyl)-vinyl]-oxacyclohexadec-13-ene-2,6-dione;
(1S,3S(E),7S,10R,11S,12S,16R)-7,11-Dihydroxy-8,8,10,12,16-pentamethyl-3-[2-(2-pyridyl)-vinyl]-4,17-dioxa-bicyclo[14.1.0]heptadecane-5,9-dione;
(4S,7R,8S,9S,13Z,16S(E))-4,8-Dihydroxy-7-ethyl-5,5,9,13-tetramethyl-16-[2(2-pyridyl)-vinyl]-oxacyclohexadec-13-ene-2,6-dione;
(1S,3S(E),7S,10R,11S,12S,16R)-7,11-Dihydroxy-10-ethyl-8,8,12,16-tetramethyl-3-[2-(2-pyridyl)-vinyl]-4,17-dioxa-bicyclo[14.1.0]heptadecane-5,9-dione;
(4S,7R,8S,9S,13Z,16S)-4,8-Dihydroxy-5,5,7,9,13-pentamethyl-16-(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-5,5,7,9,13-pentamethyl-oxacyclohexadec-13-ene-2,6-dione;
(4S,7R,8S,9S,13Z,16S)-16-(2-Aminomethyl-benzothiazol-5-yl)-4,8-dihydroxy-5,5,7,9,13-pentamethyl-oxacyclohexadec-13-ene-2,6-dione;
(1S,3S,7S,10R,11S,12S,16R)-7,11-Dihydroxy-8,8,10,12,16-pentamethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-8,8,10,12,16-pentamethyl-4,17-dioxa-bicyclo[14.1.0]heptadecane-5,9-dione;
(1S,3S,7S,10R,11S,12S,16R)-3-(2-Aminomethyl-benzothiazol-5-yl)-7,11-dihydroxy-8,8,10,12,16-pentamethyl-4,17-dioxa-bicyclo[14.1.0]heptadecane-5,9-dione;
(4S,7R,8S,9S,13Z,16S)-4,8-Dihydroxy-7-ethyl-5,5,9,13-tetramethyl-16-(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-7-ethyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-ethyl-5,5,9,13-tetramethyl-oxacyclohexadec-13-ene-2,6-dione;
(1S,3S,7S,10R,11S,12S,16R)-7,11-Dihydroxy-10-ethyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-ethyl-8,8,12,16-tetramethyl-4,17-dioxa-bicyclo[14.1.0]-heptadecane-5,9-dione;
(1S,3S,7S,10R,11S,12S,16R)-3-(2-Aminomethyl-benzothiazol-5-yl)-7,11-dihydroxy-10-ethyl-8,8,12,16-tetramethyl-4,17-dioxa-bicyclo[14.1.0]heptadecane-5,9-dione;
(4S,7R,8S,9S,13Z,16S)-4,8-Dihydroxy-7-propyl-5,5,9,13-tetramethyl-16-(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-7-propyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-propyl-5,5,9,13-tetramethyl-oxacyclohexadec-13-ene-2,6-dione;
(1S,3S,7S,10R,11S,12S,16R)-7,11-Dihydroxy-10-propyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-propyl-8,8,12,16-tetramethyl-4,17-dioxa-bicyclo[14.1.0]-heptadecane-5,9-dione;
(1S,3S,7S,10R,11S,12S,16R)-3-(2-Aminomethyl-benzothiazol-5-yl)-7,11-dihydroxy-10-propyl-8,8,12,16-tetramethyl-4,17-dioxa-bicyclo[14.1.0]heptadecane-5,9-dione;
(4S,7R,8S,9S,13Z,16S)-4,8-Dihydroxy-7-butyl-5,5,9,13-tetramethyl-16-(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-7-butyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-butyl-5,5,9,13-tetramethyl-oxacyclohexadec-13-ene-2,6-dione;
(1S,3S,7S,10R,11S,12S,16R)-7,11-Dihydroxy-10-butyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-butyl-8,8,12,16-tetramethyl-4,17-dioxa-bicyclo[14.1.0]-heptadecane-5,9-dione;
(1S,3S,7S,10R,11S,12S,16R)-3-(2-Aminomethyl-benzothiazol-5-yl)-7,11-dihydroxy-10-butyl-8,8,12,16-tetramethyl-4,17-dioxa-bicyclo[14.1.0]heptadecane-5,9-dione;
(4S,7R,8S,9S,13Z,16S)-4,8-Dihydroxy-7-allyl-5,5,9,13-tetramethyl-16-(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-7-allyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-allyl-5,5,9,13-tetramethyl-oxacyclohexadec-13-ene-2,6-dione;
(1S,3S,7S,10R,11S,12S,16R)-7,11-Dihydroxy-10-allyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-allyl-8,8,12,16-tetramethyl-4,17-dioxa-bicyclo[14.1.0]-heptadecane-5,9-dione;
(1S,3S,7S,10R,11S,12S,16R)-3-(2-Aminomethyl-benzothiazol-5-yl)-7,11-dihydroxy-10-allyl-8,8,12,16-tetramethyl-4,17dioxa-bicyclo[14.1.0]heptadecane-5,9dione;
(4S,7R,8S,9S,13Z,16S)-4,8-Dihydroxy-7-prop-2-inyl-5,5,9,13-tetramethyl-16(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-7-prop-2-inyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-prop-2-inyl-5,5,9,13-tetramethyl-oxacyclohexadec-13-ene-2,6-dione;
(1S,3S,7S,10R,11S,12S,16R)-7,11-Dihydroxy-10-prop-2-inyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-prop-2-inyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzothiazol-5-yl)-7,11-dihydroxy-10-prop-2-inyl-8,8,12,16-tetramethyl-4,17-dioxa-bicyclo[14.1.0]-heptadecane-5,9-dione;
(4S,7R,8S,9S,13Z,16S)-4,8-Dihydroxy-7-but-3-enyl-5,5,9,13-tetramethyl-16-(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-7-but-3-enyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-but-3-enyl-5,5,9,13-tetramethyl-oxacyclohexadec-13-ene-2,6-dione;
(1S,3S,7S,10R,11S,12S,16R)-7,11-Dihydroxy-10-but-3-enyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-but-3-enyl-8,8,12,16-tetramethyl-4,17-dioxa-bicyclo[14.1.0]-heptadecane-5,9-dione;
(1S,3S,7S,10R,11S,42S,16R)-3-(2-Aminomethyl-benzothiazol-5-yl)-7,11-dihydroxy-10-but-3-enyl-8,8,12,16-tetramethyl-4,17-dioxa-bicyclo[14.1.0]heptadecane-5,9-dione;
(4S,7R,8S,9S,13Z,16S)-4,8-Dihydroxy-7-but-3-inyl-5,5,9,13-tetramethyl-16-(2-methyl-benzothiazol-5-yl)-oxacyclohexadec-13-ene-2,6-dione;
(4S,7R,8S,9S,13Z,16S)-4,8-Dihydroxy-16-(2-hydroxymethyl-benzothiazol-5-yl)-7-but-3-inyl-5,5,9,13-tetramethyl-oxacyclohexadec-13-ene-2,6-dione;
(4S,7R,8S,9S,13Z,16S)-16-(2-Aminomethyl-benzothiazol-5-yl)-4,8-dihydroxy-7-but-3-inyl-5,5,9,13-tetramethyl-oxacyclohexadec-13-ene-2,6-dione;
(1S,3S,7S,10R,11S,12S,16R)-7,11-Dihydroxy-10-but-3-inyl-8,8,12,16-tetramethyl-3-(2-methyl-benzothiazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzothiazol-5-yl)-10-but-3-inyl-8,8,12,16-tetramethyl-4,17-dioxa-bicyclo[14.1.0]-heptadecane-5,9-dione;
(1S,3S,7S,10R,11S,12S,16R)-3-(2-Aminomethyl-benzothiazol-5-yl)-7,11-dihydroxy-10-but-3-inyl-8,8,12,16-tetramethyl-4,17-dioxa-bicyclo[14.1.0]heptadecane-5,9-dione;
(4S,7R,8S,9S,13Z,16S)-4,8-Dihydroxy-5,5,7,9,13-pentamethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-5,5,7,9,13-pentamethyl-oxacyclohexadec-13-ene-2,6-dione;
(4S,7R,8S,9S,13Z,16S)-16-(2-Aminomethyl-benzoxazol-5-yl)-4,8-dihydroxy-5,5,7,9,13-pentamethyl-oxacyclohexadec-13-ene-2,6-dione;
(1S,3S,7S,10R,11S,12S,16R)-7,11-Dihydroxy-8,8,10,12,16-pentamethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-8,8,10,12,16-pentamethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-8,8,10,12,16-pentamethyl-4,17-dioxa-bicyclo[14.1.0]heptadecane-5,9-dione;
(4S,7R,8S,9S,13Z,16S)-4,8-Dihydroxy-7-ethyl-5,5,9,13-tetramethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-5,5,9,13-tetramethyl-oxacyclohexadec-13-ene-2,6-dione;
(4S,7R,8S,9S,13Z,16S)- 16-(2-Aminomethyl-benzoxazol-5-yl)-4,8-dihydroxy-7-ethyl-5,5,9,13-tetramethyl-oxacyclohexadec-13-ene-2,6-dione;
(1S,3S,7S,10R,11S,12S,16R)-7,11-Dihydroxy-10-ethyl-8,8,12,16-tetramethyl-8,8,12,16-tetramethyl-3(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-ethyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10-ethyl-8,8,12,16-tetramethyl-4,17-dioxa-bicyclo[14.1.0]heptadecane-5,9-dione;
(4S,7R,8S,9S,13Z,16S)-4,8-Dihydroxy-7-propyl-5,5,9,13-tetramethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-7-propyl-5,5,9,13-tetramethyl-oxacyclohexadec-13-ene-2,6-dione;
(4S,7R,8S,9S,13Z,16S)-16-(2-Aminomethyl-benzoxazol-5-yl)-4,8-dihydroxy-7-propyl-5,5,9,13-tetramethyl-oxacyclohexadec-13-ene-2,6-dione;
(1S,3S,7S,10R,11S,12S,16R)-7,11-Dihydroxy-10-propyl-8,8,12,16-tetramethyl-3(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-propyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10-propyl-8,8,12,16-tetramethyl-4,17-dioxa-bicyclo[14.1.0]heptadecane-5,9-dione;
(4S,7R,8S,9S,13Z,16S)-4,8-Dihydroxy-7-butyl-5,5,9,13-tetramethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-7-butyl-5,5,9,13-tetramethyl-oxacyclohexadec-13-ene-2,6-dione;
(4S,7R,8S,9S,13Z,16S)-16-(2-Aminomethyl-benzoxazol-5-yl)-4,8-dihydroxy-7butyl-5,5,9,13-tetramethyl-oxacyclohexadec-13-ene-2,6-dione;
(1S,3S,7S,10R,11S,12S,16R)-7,11-Dihydroxy-10-butyl-8,8,12,16-tetramethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-butyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10-butyl-8,8,12,16-tetramethyl-4,17-dioxa-bicyclo[14.1.0]heptadecane-5,9-dione;
(4S,7R,8S,9S,13Z,16S)-4,8-Dihydroxy-7-allyl-5,5,9,13-tetramethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-7-allyl-5,5,9,13-tetramethyl-oxacyclohexadec-13-ene-2,6-dione;
(4S,7R,8S,9S,13Z,16S)-16-(2-Aminomethyl-benzoxazol-5-yl)-4,8-dihydroxy-7-allyl-5,5,9,13-tetramethyl-oxacyclohexadec-13-ene-2,6-dione;
(1S,3S,7S,10R,11S,12S,16R)-7,11-Dihydroxy-10-allyl-8,8,12,16-tetramethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-allyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10-allyl-8,8,12,16-tetramethyl-4,17-dioxa-bicyclo[14.1.0]heptadecane-5,9-dione;
(4S,7R,8S,9S,13Z,16S)-4,8-Dihydroxy-7-prop-2-inyl-5,5,9,13-tetramethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-7prop-2-inyl-5,5,9,13-tetramethyl-oxacyclohexadec-13-ene-2,6-dione;
(4S,7R,8S,9S,13Z,16S)-16-(2-Aminomethyl-benzoxazol-5-yl)-4,8-dihydroxy-7-prop-2-inyl-5,5,9,13-tetramethyl-oxacyclohexadec-13-ene-2,6-dione;
(1S,3S,7S,10R,11S,12S,16R)-7,11-Dihydroxy-10-prop-2-inyl-8,8,12,16-tetramethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-prop-2-inyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10-prop-2-inyl-8,8,12,16-tetramethyl-4,17-dioxa-bicyclo[14.1.0]-heptadecane-5,9-dione;
(4S,7R,8S,9S,13Z,16S)-4,8-Dihydroxy-7-but-3-enyl-5,5,9,13-tetramethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxymethyl-benzoxazol-5-yl)-7-but-3-enyl-5,5,9,13-tetramethyl-oxacyclohexadec-13-ene-2,6-dione;
(4S,7R,8S,9S,13Z,16S)-16-(2-Aminomethyl-benzoxazol-5-yl)-4,8-dihydroxy-7-but-3-enyl-5,5,9,13-tetramethyl-oxacyclohexadec-13-ene-2,6-dione;
(1S,3S,7S,10R,11S,12S,16R)-7,11-Dihydroxy-10-but-3-enyl-8,8,12,16-tetramethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-but-3-enyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10-but-3-enyl-8,8,12,16-tetramethyl-4,17-dioxa-bicyclo[14.1.0]heptadecane-5,9-dione;
(4S,7R,8S,9S,13Z,16S)-4,8-Dihydroxy-7-but-3-inyl-5,5,9,13-tetramethyl-16-(2-methyl-benzoxazol-5-yl)-oxacyclohexadec-13-ene-2,6-dione;
(4S,7R,8S,9S,13Z,16S)-4,8-Dihydroxy-16-(2-hydroxyethyl-benzoxazol-5-yl)-7-but-3-inyl-5,5,9,13-tetramethyl-oxacyclohexadec-13-ene-2,6-dione;
(4S,7R,8S,9S,13Z,16S)-16-(2-Aminomethyl-benzoxazol-5-yl)-4,8-dihydroxy-7-but-3-inyl-5,5,9,13-tetramethyl-oxacyclohexadec-13-ene-2,6-dione;
(1S,3S,7S,10R,11S,12S,16R)-7,11-Dihydroxy-10-but-3-inyl-8,8,12,16-tetramethyl-3-(2-methyl-benzoxazol-5-yl)-4,17-dioxa-bicyclo[14.1.0]heptadecane-5,9-dione;
(1S,3S,7S,10R,11S,12S,16R)-7,11-Dihydroxy-3-(2-hydroxymethyl-benzoxazol-5-yl)-10-but-3-inyl-8,8,12,16-tetramethyl-4,17-dioxa-bicyclo[14.1.0]heptadecane-5,9-dione;
(1S,3S,7S,10R,11S,12S,16R)-3-(2-Aminomethyl-benzoxazol-5-yl)-7,11-dihydroxy-10-but-3-inyl-8,8,12,16-tetramethyl-4,17-dioxa-bicyclo[14.1.0]heptadecane-9-dione;
whereby the hydrogen atoms in the above-mentioned effector elements are replaced by radicals L¹-L³ in the positions indicated in formula (I).

4. Effector conjugate according to claim 1, whereby the linker is selected from the group that consists of compounds of general formula (III), whereby Aa1 represents a bond.

5. Effector conjugate according to claim 1, whereby
FG¹ is C₁-C₁₀ alkyl-S₃ or

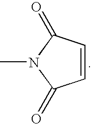

6. Effector-recognition unit conjugate of general formula (I), 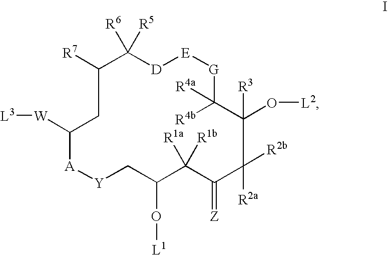
whereby the substituents here have the meanings that are mentioned in claim 1, but at least one group FG¹ is replaced by a group FG^{2a} or FG^{2b}, whereby FG^{2a} or FG^{2b} can have the following meanings:
FG^{2a} is —S—S—, 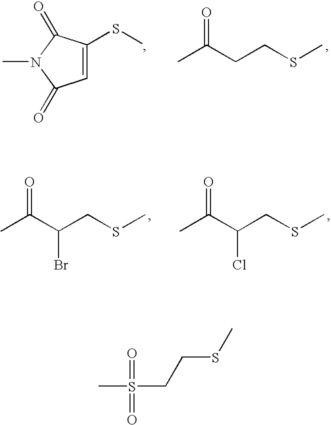
FG^{2b} is —CONH—
and whereby a recognition unit is conjugated via a sulfur atom with the group FG^{2a}, whereby the sulfur atom that is shown is a component of the recognition unit, or via an amide group with group FG^{2b}, whereby the nitrogen atom that is shown is a component of the recognition unit;
whereby the recognition unit is selected from the group that consists of peptides, soluble receptors, cytokines, lymphokines, aptamers, spiegelmers, recombinant proteins, new framework structures, monoclonal antibodies, and fragments of monoclonal antibodies;
as a uniform isomer or a mixture of different isomers and/or as a pharmaceutically acceptable salt thereof.

7. Effector-recognition unit conjugate according to claim 6, whereby the conjugate contains more than one recognition unit, and whereby the recognition units are identical.

8. Effector-recognition unit conjugate according to claim 6, whereby the recognition unit is an antibody or an antigen-binding fragment of the same, which is specific to an antigen that is selected from the group that consists of the antigens that are indicated in Table 1, as well as CD19, CD20, CD40, CD22, CD25, CD5, CD52, CD10, CD2, CD7, CD33, CD38, CD40, CD72, CD4, CD21, CD37, CD30, VCAM, CD31, ELAM, endoglin, VEGFRI/II, VEGFRvIII, scFv(14E1), αᵥβ₃, Tie½, TES23 (CD44ex6), phosphatidylserine, PSMA, VEGFR/VEGF complex and ED-B-fibronectin.

9. Linkers of general formula (III¹): 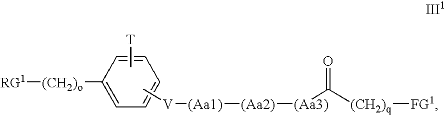
in which p1 RG¹ is an O═C═N group, and o, V, q, T, Aa1, Aa2, Aa3 and FG¹ have the meanings that are mentioned in claim 1;
or linkers of general formula (III²): 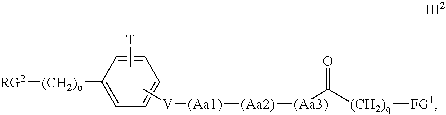
in which
RG² is a Hal-C(═O)—CHR²² group or a Hal-C(═O)—CHR²²—NR²³—C(═O) group, or an R²⁶—C(═O)—O—C(═O)—CHR²² group or an R²⁶—C(═O)—O—C(═O)—CHR²²—NR²³—C(═O) group, whereby R²⁶ is C₁-C₁₀ alkyl, aryl, or aralkyl, and o, V, q, T, Aa1, Aa2, Aa3 and FG¹ have the meanings that are mentioned in claim 1;
or linkers of general formula (III³): 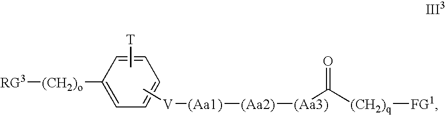
in which
RG³ is an OH group or an NHR^{24a} group or a COOH group, and o, V, q, T, Aa1, Aa2, Aa3 and FG¹ have the meanings that are mentioned in claim 1.

10. Process for the production of effector conjugates according to claim 1, whereby a compound of general formula (I), whereby the substituents have the meanings that are mentioned in claim 1, but
the condition that at least one group L¹, L² or L⁴ represent a linker of general formula (III) need not be met, and at least one substituent L¹, L² or L⁴ represents hydrogen or a group C(═O)Cl;
is reacted with a linker that is selected from the group that consists of a linker of general formula (III¹) or (III²) or (III³), as 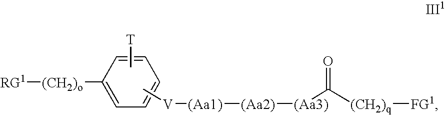
in which
RG¹ is an O═C═N group, and o, V, q, T, Aa1, Aa2, Aa3 and FG¹ have the meanings that are mentioned in claim 1;
or linkers of general formula (III²): 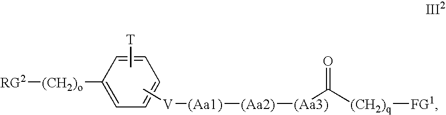
in which
RG² is a Hal-C(═O)—CHR²² group or a Hal-C(═O)—CHR²²—NR²³—C(═O) group, or an R²⁶—C(═O)—O—C(═O)—CHR²² group or an R²⁶—C(═O)—O—C(═O)—CHR²²—NR²³—C(═O) group, whereby R²⁶ is C₁-C₁₀ alkyl, aryl, or aralkyl, and o, V, q, T, Aa1, Aa2, Aa3 and FG¹ have the meanings that are mentioned in claim 1;
or linkers of general formula (III³): 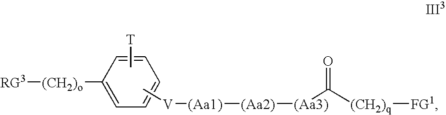
in which
RG³ is an OH group or an NHR^{24a} group or a COOH group, and o, V, q, T, Aa1, Aa2, Aa3 and FG¹ have the meanings that are mentioned in claim 1.

11. Process for the production of effector-recognition unit conjugates according to claim 6, whereby an effector conjugate is reacted with at least one recognition unit.

12. (canceled)

13. Use of a compound of general formula (I) for the production of an effector-recognition unit conjugate according to claim 6.

14. Use of a linker of general formula (III¹), (III²) or (III³) in a process according to claim 10.

15. Use of a linker of general formula (III¹), (III²) or (III³) for the production of an effector-recognition unit conjugate according to claim 6.

16. (canceled)

17. Effector-recognition unit conjugate according to claim 6 for use as a medication.

18. Effector-recognition unit conjugate according to claim 6 for use as a medication for treating diseases that are associated with proliferative processes.

19. Effector-recognition unit conjugate according to claim 6 for use as a medication for treating a disease, which is selected from the group that consists of tumors, inflammatory diseases, neurodegenerative diseases, angiogenesis-associated diseases, multiple sclerosis, Alzheimer's disease and rheumatoid arthritis.
